(19) United States
(12) Patent Application Publication
(10) Pub. No.: US 2021/0365931 A1
(43) Pub. Date: Nov. 25, 2021

(54) MOBILE TERMINAL, INFORMATION PROCESSING METHOD, AND INFORMATION PROCESSING PROGRAM

(71) Applicant: Rakuten Group, Inc., Tokyo (JP)

(72) Inventor: Hiroshi SHINOHARA, Tokyo (JP)

(73) Assignee: Rakuten Group, Inc., Tokyo (JP)

(21) Appl. No.: 16/326,462

(22) PCT Filed: Aug. 31, 2016
(86) PCT No.: PCT/JP2016/075430

§ 371 Date: Jul. 30, 2021

(51) Int. Cl. G06Q 20/36; G06Q 20/32; G06Q 20/24; G06Q 20/12; G06Q 20/40

(52) U.S. Cl. CPC G06Q 20/3672; G06Q 20/3278; G06Q 20/24; G06Q 20/3674; G06Q 20/407; G06Q 20/3224; G06Q 20/127

(57) ABSTRACT

A mobile terminal 1 measures a distance between the mobile terminal 1 and a wireless communication device 2a on the basis of a radio signal transmitted from the wireless communication device 2a connected to an electronic money payment machine, and the mobile terminal 1 transmits an authorization request for a credit payment of a recharge amount for recharging an electronic value balance to a center server 4 when detecting, on the basis of the measured distance, that the mobile terminal 1 is approaching the wireless communication device 2a, and performs processing of permitting recharge of the electronic value balance with the recharge amount when a credit approval is granted for the authorization according to the authorization request.

### TECHNICAL FIELD

The present invention relates to a technical field of a mobile terminal or the like configured to be used for an electronic money payment of electronic value.

### BACKGROUND ART

Conventionally, a function of automatically recharging an electronic value balance stored in a mobile terminal carried by a user is known. Such a function is called an automatic recharge function. With the automatic recharge function, the user's credit card number can be registered in advance in a predetermined server to automatically recharge an electronic value balance with a given recharge amount by credit card payment. For example, it is assumed that the automatic recharge function is configured so that if the electronic value balance is ¥1,000 or less, the electronic value balance is recharged with a recharge amount of ¥1,000. In this case, when the user taps his/her mobile terminal on a reader/writer of a payment machine upon payment at a shop, a ticket gate of a station, or the like, an electronic value balance of ¥1,000 or less at that time is recharged with (increased by) ¥1,000 by a credit card payment, and a payment amount necessary for the payment is reduced from the electronic value balance.

Meanwhile, a technique for automatically recharging an electronic value balance with a predetermined recharge amount by credit card payment is also disclosed in Patent Literature 1. According to Patent Literature 1, a mobile terminal periodically determines whether a value balance is equal to or smaller than a balance reference amount, and when the value balance is equal to or smaller than the balance reference amount, the mobile terminal accesses an electronic money server to request automatic recharging. Then, in response to the request from the mobile terminal, the electronic money server accesses a credit company server and performs processing of paying a recharge amount with a credit card number registered by the user.

### CITATION LIST

### Patent Literature

Patent Literature 1: JP 5619719 B2

### SUMMARY OF INVENTION

### Technical Problem

Incidentally, in the credit card payment, in order to check the credit status of the user, an authorization is usually made, for example, by a predetermined server. On the other hand, in electronic money payment, it is demanded to complete recharge with the recharge amount and reducing the payment amount in a short time (for example, within one second) during which the user taps the mobile terminal on the reader/writer of the payment machine, in view of the convenience in service. For this reason, in the automatic recharge function in this case, the recharge with the recharge amount may be performed without the authorization. However, even in such an automatic recharge function, it is desirable to perform the recharge with the recharge amount, after the authorization is made. As described in Patent Literature 1, it is convenient for the user to automatically and periodically perform recharge with the recharge amount, but inconvenience may occur in view of loss, theft, or the like of the mobile terminal.

The present invention is made in view of the above problems and the like, and an object of the present invention is to provide a mobile terminal, an information processing method, and an information processing program which permit recharging an electronic value balance with a predetermined recharge amount, after performance of authorization for a credit card payment with more appropriate timing.

### Solution to Problem

In order to solve the above problem, the invention of claim 1 is a mobile terminal carried by a user, configured to be used for electronic money payment of electronic value stored in a predetermined storage means, the mobile terminal comprising:

a communication means that communicates with a predetermined server via a network;

a reception means that receives a radio signal transmitted from a wireless communication device provided integrally with or separately from a device capable of performing electronic money payment or a device capable of recharging an electronic value balance with a recharge amount;

a measurement means that measures a distance between the mobile terminal and the wireless communication device on the basis of the radio signal received by the reception means;

a detection means that detects that the mobile terminal is approaching the wireless communication device on the basis of a distance measured by the measurement means;

an authorization requesting means that transmits a request for authorization for a credit payment for a recharge amount for recharging the electronic value balance, to the server via the network, when approaching of the mobile terminal to the wireless communication device is detected by the detection means; and

a processing means that performs processing of permitting recharging the electronic value balance with the recharge amount when credit approval is granted for the authorization.

According to the present invention, after the authorization for a credit card payment is made at more appropriate timing, recharging the electronic value balance with the recharge amount is permitted.

The invention of claim 2 is the mobile terminal according to claim 1, further comprising

a determination means that determines whether electronic value balance stored in the storage means is equal to or smaller than a first threshold value or smaller than the first threshold value,

wherein the authorization requesting means transmits the authorization request only when the determination means determines that the balance is equal to or smaller than the first threshold value or smaller than the first threshold value.

According to the present invention, the authorization is permitted only when really required, for example, for preventing an insufficient balance, and a processing load applied on the mobile terminal and server due to the authorization can be reduced.

The invention of claim 3 is the mobile terminal according to any of claims 1 and 2, wherein the processing means performs processing of permitting recharging the electronic value balance with the recharge amount only when credit approval is granted for the authorization and a distance measured by the measurement means is equal to or smaller than a second threshold value or smaller than the second threshold value.

According to the present invention, since the recharge with the recharge amount is performed, for example, only when the possibility of electronic money payment is high, a processing load applied on the mobile terminal and server due to the recharge with the recharge amount can be reduced.

The invention of claim 4 is the mobile terminal according to claim 3, further comprising a setting means that sets the second threshold value larger as a moving speed of the mobile terminal is faster, the moving speed is calculated on the basis of a difference between distances and a difference in measurement time, and the difference between distances is obtained by measuring distances a plurality of times by the measurement means at different timings.

According to the present invention, for example, recharge of electronic value with a recharge amount can be surely permitted before electronic money payment.

The invention of claim 5 is the mobile terminal according to claim 3, further comprising a setting means that identifies time in the past at which the electronic money payment is made by the device capable of performing electronic money payment, from a payment history of the user, and sets the second threshold value larger as an expectation value of the electronic money payment made through the device capable of performing electronic money payment in a time block including the identified time is larger.

According to the present invention, for example, recharge of electronic value with a recharge amount can be surely permitted before electronic money payment.

The invention of claim 6 is the mobile terminal according to any one of claims 1 to 5, further comprising:

a first acquisition means that acquires a necessary time required for the authorization; and

a calculation means that calculates expected arrival time at which the user arrives at the device, on the basis of moving speed and a latest distance, the moving speed is calculated on the basis of a difference between distances and a difference in measurement time, the difference between distances being obtained by measuring distances a plurality of times by the measurement means at different timings, and the latest distance being measured by the measurement means,

wherein the detection means detects that the mobile terminal is approaching the wireless communication device, at a point of time earlier by the necessary time before the expected arrival time.

According to the present invention, it is possible to further reduce unnecessary authorization, and it is possible to reduce a processing load applied on the mobile terminal and server due to the authorization.

The invention of claim 7 is the mobile terminal according to any one of claims 1 to 6, further comprising a cancellation requesting means that transmits a request for cancellation of the credit approval to the server via the network, when the electronic money payment of the electronic value is not performed within a predetermined time period after credit approval is granted for the authorization for the recharge amount.

According to the present invention, it is possible to quickly cancel a secured recharge amount for which the credit approval is granted, restoring a previous available amount for the credit card payment.

The invention of claim 8 is the mobile terminal according to any one of claims 1 to 6, further comprising a cancellation requesting means that transmits the request for cancellation of the credit approval to the server via the network, when electronic money payment of the electronic value is not performed within a predetermined time period after the radio signal is not received by the reception means after credit approval is granted for the authorization.

According to the present invention, it is possible to quickly cancel a secured recharge amount for which the credit approval is granted, restoring a previous available amount for the credit card payment.

The invention of claim 9 is the mobile terminal according to any one of claims 1 to 8, further comprising:

a second acquisition means that acquires payment amount information indicating a payment amount necessary for payment through the device capable of performing electronic money payment; and

a determination means that determines the recharge amount on the basis of a payment amount indicated by the payment amount information acquired by the second acquisition means and the electronic value balance,

wherein the authorization requesting means transmits a request for authorization for a credit payment of the recharge amount determined by the determination means.

According to the present invention, it is possible to determine a minimum recharge amount required for an electronic money payment to be made later, in consideration of the electronic value balance.

The invention of claim 10 is the mobile terminal according to claim 9, wherein the second acquisition means acquires the payment amount information from the radio signal received by the reception means.

According to the present invention, it is possible to quickly acquire the payment amount information indicating a payment amount necessary for payment through the device for making an electronic money payment.

The invention of claim 11 is the mobile terminal according to claim 9, wherein the second acquisition means identifies, from the payment history of the user, a payment amount of the electronic money paid in the past through the device capable of performing electronic money payment, and acquires payment amount information indicating the identified payment amount, as payment amount information indicating a payment amount necessary for payment through the device capable of performing electronic money payment.

According to the present invention, even where the payment amount information cannot be acquired from the radio signal, it is possible to accurately acquire a payment amount necessary for payment through the device for performing electronic money payment.

The invention of claim 12 is an information processing method performed by a mobile terminal carried by a user and configured to be used for electronic money payment of electronic value stored in a predetermined storage means, the method comprising:

a reception step of receiving a radio signal transmitted from a wireless communication device provided integrally with or separately from a device capable of performing electronic money payment or a device capable of recharging an electronic value balance with a recharge amount;

a measurement step of measuring a distance between the mobile terminal and the wireless communication device on the basis of the radio signal received in the reception step;

a detection step of detecting that the mobile terminal is approaching the wireless communication device on the basis of a distance measured in the measurement step;

an authorization requesting step of transmitting a request for authorization for a credit payment for a recharge amount for recharging the electronic value balance, to a predetermined server via a network, when approaching of the mobile terminal to the wireless communication device is detected in the detection step; and

a processing step of performing processing of permitting recharge of the electronic value balance with the recharge amount when credit approval is granted for the authorization.

The invention of claim 13 is an information processing program for causing a computer included in a mobile terminal carried by a user and configured to be used for electronic money payment of electronic value stored in a predetermined storage means to function as:

a measurement means that measures a distance between the mobile terminal and a wireless communication device on the basis of a radio signal transmitted from the wireless communication device provided integrally with or separately from a device capable of performing electronic money payment or a device capable of recharging an electronic value balance with a recharge amount, and received by a reception means of the mobile terminal;

a detection means that detects that the mobile terminal is approaching the wireless communication device on the basis of a distance measured by the measurement means;

an authorization requesting means that transmits a request for authorization for a credit payment for a recharge amount for recharging the electronic value balance, to a predetermined server via a network, when approaching of the mobile terminal to the wireless communication device is detected by the detection means; and

a processing means that performs processing of permitting recharge of the electronic value balance with the recharge amount when credit approval is granted for the authorization.

### Advantageous Effects of Invention

According to the present invention, after the authorization for a credit card payment is made at more appropriate timing, recharging the electronic value balance with the recharge amount is permitted.

### BRIEF DESCRIPTION OF DRAWINGS

FIG. 1 is a diagram illustrating a schematic configuration example of an electronic payment system S according to the present embodiment.

FIG. 2A is a diagram illustrating a schematic configuration example of a mobile terminal 1, and FIG. 2B is a diagram illustrating an example of functional blocks of a control unit 17.

FIG. 3 is a sequence diagram illustrating an operation example where automatic recharging is performed through an electronic money payment machine 3 and then electronic money payment is made through the electronic money payment machine 3.

FIG. 4 is a sequence diagram illustrating an operation example where automatic recharging is performed through the electronic money payment machine 3 and then electronic money payment is made through the electronic money payment machine 3.

FIG. 5 is a sequence diagram illustrating an operation example where automatic recharging and electronic money payment are simultaneously performed through the electronic money payment machine 3.

FIG. 6 is a sequence diagram illustrating an operation example where automatic recharging and electronic money payment are simultaneously performed through the electronic money payment machine 3.

FIG. 7 is a sequence diagram illustrating an operation example where automatic recharging is performed by a center server 4 and then electronic money payment is made through the electronic money payment machine 3.

FIG. 8 is a sequence diagram illustrating an operation example where automatic recharging is performed by the center server 4 and then electronic money payment is made through the electronic money payment machine 3.

### DESCRIPTION OF EMBODIMENTS

Hereinafter, embodiments of the present invention will be described with reference to the drawings. It is to be noted that the embodiments described below are embodiments where the present invention is applied to an electronic payment system.

### [1. Configuration and Functional Overview of Electronic Payment System]

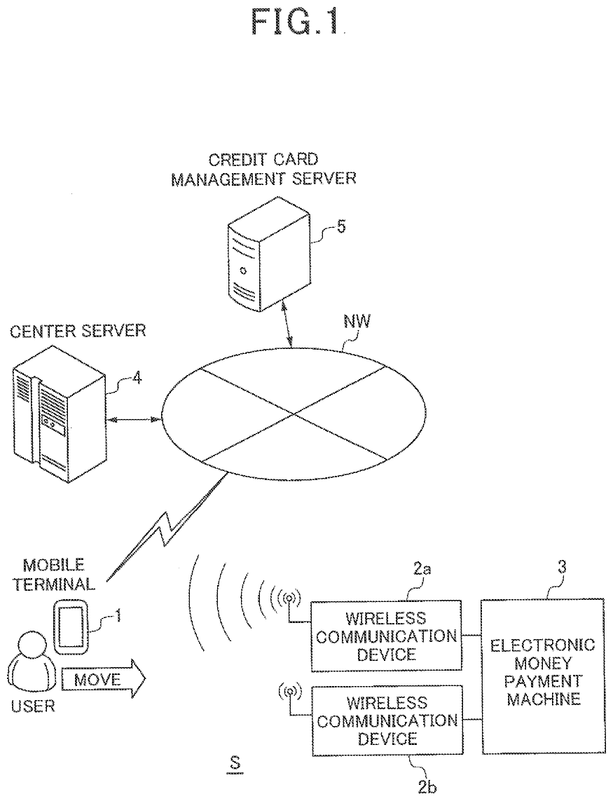

Firstly, a configuration and functional overview of an electronic payment system S according to the present embodiment will be described with reference to FIG. 1 and the like. FIG. 1 is a diagram illustrating a schematic configuration example of the electronic payment system S according to the present embodiment. As illustrated in FIG. 1, the electronic payment system S includes a mobile terminal 1 carried by a user, wireless communication devices 2a and 2b, an electronic money payment machine 3, a center server 4, a credit card management server 5, and the like. The mobile terminal 1 and the electronic money payment machine 3 are configured to perform wireless communication via the wireless communication devices 2a and 2b. The center server 4 and the credit card management server 5 are connected to the network NW, respectively. The network NW is constituted by, for example, the Internet, a mobile communication network (including a base station and the like), a gateway, and the like. The center server 4 and the credit card management server 5 are configured to perform wireless communication via the network NW or a dedicated line. The mobile terminal 1 and the center server 4 are configured to communicate with each other via the network NW.

The mobile terminal 1 is a mobile terminal configured to use electronic value, such as electronic money, having a monetary value for electronic money payment. The electronic value is digital data indicating a monetary value. Note that the electronic money includes electronic money as a prepaid stored value and electronic money as a monetary value prepaid and stored in a server. The electronic money as a prepaid stored value has electronic value stored in a predetermined storage means in the mobile terminal 1. On the other hand, the electronic money as a monetary value prepaid and stored in a server has a value stored in a predetermined storage means in an electronic money management server (not illustrated). In the present embodiment, the electronic money as a prepaid stored value will be described as an example. Within a wireless communication range of the wireless communication device 2b, the mobile terminal 1 transmits (wirelessly transmits) a payment request for electronic money payment of a given payment amount to the electronic money payment machine 3 via the wireless communication device 2b. Here, the payment request includes information about the electronic value balance or the like. The payment amount is, for example, a fee necessary for payment through the electronic money payment machine 3, and is set in advance on the facility side (that is, on the side of a facility administration entity).

For example, when it is detected that the mobile terminal 1 is within the wireless communication range of the wireless communication device 2a and approaching the wireless communication device 2a before the electronic money payment is made, the mobile terminal 1 transmits a request for an authorization for a credit card payment for a given recharge amount for recharging the electronic value balance (hereinafter referred to as “authorization request”) to the center server 4 via the network NW Thus, the authorization request is transferred from the center server 4 to the credit card management server 5. Here, the authorization for a credit card payment for a recharge amount represents checking whether credit card payment can be used for the recharge amount. The authorization request includes information, such as a credit card number of a credit card of the user of the mobile terminal 1, credit card holder (user to whom the credit card has been issued), credit card expiration date, recharge amount (amount paid), facility ID, for example. Here, the facility ID is identification information for identifying a facility where the electronic money payment machine 3 is installed, and may be a facility name.

When the authorization is made by the credit card management server 5 in response to the authorization request, the result of the authorization (hereinafter referred to as “authorization result”) is returned to the center server 4. The authorization result includes information indicating whether credit approval has been granted, the facility ID, and the like. Then, when the authorization result includes information indicating a credit approval granted for the authorization (hereinafter referred to as “credit approval information”) (that is, credit approval is granted) within the wireless communication range of the wireless communication device 2a, the mobile terminal 1 transmits (wirelessly transmits) a recharge request for automatic recharging with the recharge amount, to the electronic money payment machine 3 via the wireless communication device 2a. Here, the automatic recharging means to automatically recharge the electronic value balance. The recharge request includes, for example, a recharge amount and the authorization result. Alternatively, when the authorization result includes the credit approval information within the wireless communication range of the wireless communication device 2a, the mobile terminal 1 may transmit the recharge request for automatic recharging with the recharge amount, to the center server 4 via the network NW Note that within the wireless communication range of the wireless communication device 2a or the wireless communication device 2b, the mobile terminal 1 may transmit a recharge & payment request in which the recharge request and the payment request are integrated to the electronic money payment machine 3 via the wireless communication device 2a or wireless communication device 2b.

The wireless communication devices 2a and 2b are provided integrally with or separately from the electronic money payment machine 3, and are connected to the electronic money payment machine 3. That is, the wireless communication devices 2a and 2b may be incorporated in the electronic money payment machine 3, or may be installed outside the electronic money payment machine 3 (for example, installed in the vicinity of the electronic money payment machine 3) to be connected to the electronic money payment machine 3 via wired or wireless connection. Note that the wireless communication device 2b may be provided integrally with the electronic money payment machine 3, and the wireless communication device 2a may be provided separately from the electronic money payment machine 3. The wireless communication device 2a is a communication device for performing short-range wireless communication by using, for example, Bluetooth Low Energy (BLE) technology communication protocol. The technology of BLE is developed as part of the Bluetooth (registered trademark) 4.0 standard, and is a wireless communication technology using a 2.4 GHz band. The wireless communication device 2a has a communication distance set to, for example, approximately 0 to 50 m. When the mobile terminal 1 is within the wireless communication range determined depending on the communication distance of the wireless communication device 2a, a radio signal (carrier wave) from the wireless communication device 2a is received by the mobile terminal 1 (a first short-range wireless communication unit 14, described later), and the wireless communication device 2a and the mobile terminal 1 automatically communicate with each other wirelessly. The radio signal continuously transmitted from the wireless communication device 2a includes the facility ID (for example, universally unique identifier (UUID)) for identifying a facility where the electronic money payment machine 3 is installed. That is, the carrier wave continuously transmitted from the wireless communication device 2a is modulated with data indicating the facility ID. Furthermore, in addition to the facility ID, payment amount information indicating a payment amount necessary for payment through the electronic money payment machine 3 may be included in the radio signal continuously transmitted from the wireless communication device 2a.

On the other hand, the wireless communication device 2b is a communication device (so-called reader/writer) for performing short-range wireless communication by using, for example, near field radio communication (NFC) technology communication protocol (international standard). The technology of NFC is a type of radio frequency identification (RFID) technology and is a wireless communication technology using a 13.56 MHz band. The wireless communication device 2b has a communication distance set to, for example, approximately zero to several centimeters. That is, the communication distance of the wireless communication device 2b is shorter than the communication distance of the wireless communication device 2a. When the mobile terminal 1 is within the wireless communication range determined depending on the communication distance of the wireless communication device 2b, a radio signal (carrier wave) from the wireless communication device 2b is received by the mobile terminal 1 (a second short-range wireless communication unit 15, described later), and the wireless communication device 2b and the mobile terminal 1 automatically communicate with each other wirelessly. The radio signal transmitted from the wireless communication device 2b also includes the facility ID for identifying a facility where the electronic money payment machine 3 is installed. Note that a wireless communication technology other than the technologies of NFC and BLE described above may be used for each of the wireless communication devices 2a and 2b.

The electronic money payment machine 3 is a device capable of making an electronic money payment and further is a device capable of recharging an electronic value balance with a recharge amount. The electronic money payment machine 3 is installed in a facility, at a doorway of a facility, or the like. Examples of the facilities include shops, amusement parks, movie theaters, museums, art museums, zoos, baseball stadiums, ball game grounds, stations, and the like. The electronic money payment machine 3 is installed at, for example, a checkout counter of a shop providing goods or services, a ticket gate of a station, or the like. The electronic money payment machine 3 receives the payment request, recharge request, or recharge & payment request from the mobile terminal 1 via the wireless communication device 2a or the wireless communication device 2b. The electronic money payment machine 3 makes an electronic money payment in response to the payment request from the mobile terminal 1. In the electronic money payment, when determining that an electronic value balance is equal to or larger than the payment amount, the electronic money payment machine 3 transmits (wirelessly transmits) a balance change command for subtracting the payment amount from the electronic value balance to the mobile terminal 1 via the wireless communication device 2b. Thus, the payment amount is subtracted (reduced) from the electronic value balance.

Furthermore, in response to the recharge request from the mobile terminal 1, the electronic money payment machine 3 performs automatic recharging when the authorization result includes the credit approval information. In this automatic recharging, the electronic money payment machine 3 transmits (wirelessly transmits) a balance change command for adding a recharge amount to an electronic value balance to the mobile terminal 1 via the wireless communication device 2a. Therefore, a recharge amount is added (increased) to the electronic value balance. In addition, in response to the recharge & payment request from the mobile terminal 1, the electronic money payment machine 3 performs automatic recharging and electronic money payment when the authorization result includes the credit approval information. In this automatic recharging and electronic money payment, when determining that an amount obtained by adding a recharge amount to the electronic value balance is equal to or larger than the payment amount, the electronic money payment machine 3 transmits (wirelessly transmits) a balance change command for adding the recharge amount to the electronic value balance and subtracting the payment amount from the electronic value balance to the mobile terminal 1 via the wireless communication device 2a or the wireless communication device 2b. Thus, the payment amount is subtracted from the amount obtained by adding a recharge amount to the electronic value balance. In other words, for example, a difference amount of ¥500 between a recharge amount of ¥1,000 and a payment amount of ¥1,500 is subtracted (recharge amount<payment amount) from a balance of ¥1,000, and the balance is updated to ¥500. Alternatively, a difference amount of ¥500 between a recharge amount of ¥2,000 and a payment amount of ¥1,500 is added (recharge amount>payment amount) to a balance of ¥1,000, and the balance is updated to ¥1,500.

The center server 4 is a server mediating exchange of information between the mobile terminal 1 and the credit card management server 5 or the like. Upon receiving an authorization request from the mobile terminal 1, the center server 4 transmits the authorization request to the credit card management server 5 via the network NW or the dedicated line. Then, upon receiving an authorization result from the credit card management server 5, the center server 4 transmits the authorization result to the mobile terminal 1 via the network NW Alternatively, the center server 4 may hold an authorization result from the credit card management server 5 in association with information specific to the mobile terminal 1 (hereinafter referred to as “terminal specific information”) (in this case, the authorization result may not be transmitted to the mobile terminal 1). Furthermore, upon receiving a recharge request from the mobile terminal 1, the center server 4 can perform automatic recharging in response to the recharge request, when credit approval information is included in the authorization result. In this automatic recharging, the center server 4 transmits a balance change command for adding a recharge amount to an electronic value balance to the mobile terminal 1 via the network. Therefore, a recharge amount is added to the electronic value balance. Note that the center server 4 may have a function of a Trusted Service Manager (TSM) server for performing access management or the like on a secure element 16, which is described later.

The credit card management server 5 is a server for managing credit card information. The credit card management server 5 includes a storage unit in which information, such as a credit card number, credit card holder, credit card expiration date, a credit limit (credit ceiling), available amount, credit history data, user account information, and user ID, is stored in association with each user. The credit card number is a unique number to each credit card, and it is possible to specify a user to whom the credit card is issued. The credit limit represents, for example, a limit permitted for shopping or recharging with electronic value by using a credit card. The available amount is a total amount which can be used for credit card payment at the present time (in other words, for which a credit card can be used) and is, for example, an amount obtained by subtracting an amount paid in the current month from the credit limit. The amount paid in the current month is a payment amount paid by the credit card in the current month (for example, this month). The amount paid in the current month can be obtained from the credit history data described above. This credit history data is data indicating credit card payment history, and is generated by the credit card management server 5 when a credit card payment is made. Here, “when a credit card payment is made” corresponds to “when an authorization result (including credit approval information) is transmitted to the center server 4” or “when an authorization result (including credit approval information) is transmitted to the center server 4 followed by transmitting, from the center server 4, an acknowledgment to the authorization result”. Alternatively, “when a credit card payment is made” may correspond to “when information representing performance of automatic recharging according to credit approval information is received from the mobile terminal 1 via the center server 4. In the credit history data, information, such as a date (transaction date) of a credit card payment, facility ID, and amount paid, for example, is recorded. The date is, for example, year, month, and day, and may include time (hereinafter the same shall apply).

Note that, for example, it is possible to cancel the credit approval during a period from the time at which a credit approval is granted for an amount paid (for example, a recharge amount) (the recharge amount is secured for a credit card payment), to the time at which this amount paid is paid from an acquirer (for example, a credit card company) to a merchant (for example, a merchant providing electronic value relating to a recharge amount). When the credit approval is canceled, for example, information indicating cancellation of the credit approval for the facility ID and transaction date is additionally recorded in the credit history data, and the available amount is changed. The user account information includes, for example, an account number of an account (user's account) from which an amount paid by credit card payment is withdrawn, a withdrawal date, and a bank name ID for identifying a bank managing the account. Furthermore, the storage unit of the credit card management server 5 stores information, such as a merchant ID for identifying a credit card merchant from credit card merchants and merchant account information, in association with each of the merchants. The merchants are administration entities (operators) of the facilities described above. The merchant account information includes, for example, an account number of an account (account of a merchant) to which an amount paid by credit card payment is transferred, and a bank name ID for identifying a bank managing the account.

In particular, when receiving an authorization request from the center server 4, the credit card management server 5 makes an authorization for a credit card payment for a recharge amount for recharging an electronic value balance. In this authorization, it is checked whether a credit card expires, whether a recharge amount (amount paid) exceeds an available amount, or the like. Then, when it is checked that, for example, the credit card does not expire and the recharge amount (amount paid) does not exceed an available amount (in other words, when a credit approval is granted), the credit card management server 5 returns an authorization result (including credit approval information) to the center server 4. Such credit approval information includes information, such as a date at which a credit approval is granted (approval date), amount for which the credit approval is granted (approval amount), facility ID, and credit card number. Then, when the above-described automatic recharging is performed through the electronic money payment machine 3 or the center server 4 according to the credit approval information, an administration entity, which manages the electronic money payment machine 3 or the center server 4, transmits billing data for a recharge amount to the credit card management server 5. Accordingly, the recharge amount is paid to the administration entity (merchant) from the acquirer (for example, withdrawn from an account (balance of the account) of the acquirer and is transferred to the account of the merchant). Then, the recharge amount and a charge are withdrawn from the user's account.

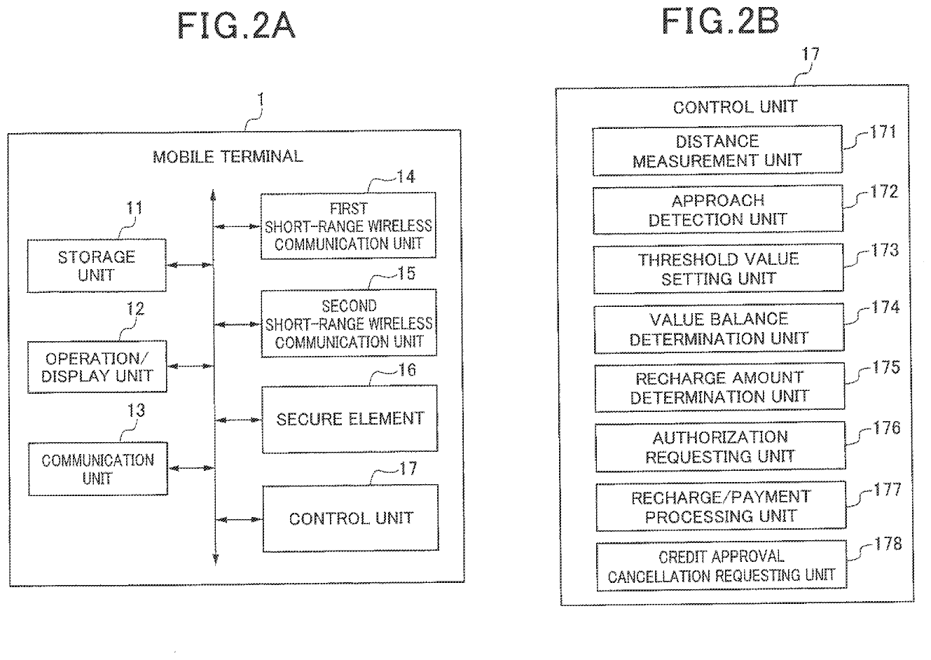

FIG. 2A is a diagram illustrating a schematic configuration example of the mobile terminal 1. As illustrated in FIG. 2A, the mobile terminal 1 includes a storage unit 11, an operation/display unit 12, a communication unit 13, the first short-range wireless communication unit 14, the second short-range wireless communication unit 15, the secure element 16, a control unit 17, and the like. Note that, examples of the mobile terminal 1 applicably include a smartphone, a mobile phone, a tablet, a personal digital assistant (PDA), a portable video game machine, and the like. The storage unit 11 is constituted by, for example, a nonvolatile memory, and stores an operating system (OS), an application (program), and the like. The application installed in the mobile terminal 1 includes an information processing program according to the present invention. Note that the information processing program may be downloaded from a predetermined server to the mobile terminal 1, or may be recorded (recorded to be read by a computer) on a recording medium, such as a CD or a DVD, to be read from the recording medium and stored in the storage unit 11. Furthermore, the storage unit 11 stores access information (for example, IP address and port number) and the like for access to the center server 4.

The operation/display unit 12 includes, for example, a touch panel having an input function for receiving an operation by a user's finger, a pen or the like and a display function for displaying information. The operation/display unit 12 receives an operation from the user and outputs a signal corresponding to the operation to the control unit 17. The communication unit 13 (example of a communication means) plays a role to communicate with the center server 4 and the like via the network NW The first short-range wireless communication unit 14 includes, for example, an IC chip and an antenna, and plays a role to perform short-range wireless communication with the wireless communication device 2a by using the BLE technology communication protocol. The first short-range wireless communication unit 14 is an example of a reception means that receives the radio signal transmitted from the wireless communication device 2a. Note that the first short-range wireless communication unit 14 measures, whenever receiving the radio signal continuously transmitted from the wireless communication device 2a, a radio field strength of the carrier wave, demodulates the carrier wave to acquire data (facility ID and the like), and outputs the acquired radio field strength and demodulated data to the control unit 17. The second short-range wireless communication unit 15 includes, for example, an IC chip and an antenna or the like, and plays a role to perform short-range wireless communication with the wireless communication device 2b by using the NFC technology communication protocol.

The secure element 16 includes an IC module (for example, an IC chip) with a secure memory for securely storing data against an analysis attack from outside. The secure element 16 stores a secure ID being information specific to the secure element 16. The secure element 16 includes an applet (for example, Java (registered trademark) application) for managing data stored in the secure memory. Data stored in the secure memory includes electronic money payment data and credit card payment data. Here, the electronic money payment data includes data, such as an electronic value balance, electronic money card number, and log data (payment history data, recharge history data). This payment history data is data indicating electronic money payment history (an example of user payment history), and is generated through the electronic money payment machine 3 when an electronic money payment is made. In this payment history data, information, such as a date (payment date) of an electronic money payment, facility ID, and payment amount, for example, is recorded. The recharge history data is data indicating electronic value recharge history, and is generated by the electronic money payment machine 3 or the center server 4 when a recharging is made with the electronic value. In the recharge history data, information, such as a date (recharge date) of recharging with the electronic value, facility ID, and recharge amount, for example, is recorded. On the other hand, the credit card payment data includes data, such as a credit card number, credit card holder, and a credit card expiration date.

The control unit 17 includes a central processing unit (CPU), a read only memory (ROM), a random access memory (RAM), and the like. FIG. 2B is a diagram illustrating an example of functional blocks of the control unit 17. As illustrated in FIG. 2B, the control unit 17 (a processor in the control unit 17) executes the applications on the OS to function as a distance measurement unit 171, an approach detection unit 172, a threshold value setting unit 173, a value balance determination unit 174, a recharge amount determination unit 175, an authorization requesting unit 176, a recharge/payment processing unit 177, a credit approval cancellation requesting unit 178, and the like, and performs processing, which is described later. Here, the distance measurement unit 171 is an example of a measurement means according to the present invention. The approach detection unit 172 is an example of a detection means, a first acquisition means, and a calculation means according to the present invention. The threshold value setting unit 173 is an example of a setting means according to the present invention. The value balance determination unit 174 is an example of a determination means according to the present invention. The recharge amount determination unit 175 is an example of a determination means and a second acquisition means according to the present invention. The authorization requesting unit 176 is an example of an authorization requesting means according to the present invention. The recharge/payment processing unit 177 is an example of processing means according to the present invention. The credit approval cancellation requesting unit 178 is an example of a cancellation requesting means according to the present invention.

The distance measurement unit 171 measures a distance between the mobile terminal 1 and the wireless communication device 2a on the basis of a radio signal (that is, a carrier wave transmitted from the wireless communication device 2a) received by the first short-range wireless communication unit 14. For example, the distance measurement unit 171 acquires a radio field strength of the carrier wave from the first short-range wireless communication unit 14 to measure the distance d (m) by using the acquired radio field strength rs (dBm) and, for example, the following formula (1).

Radio field strength rs=k(1/distance d²) (1)

Here, k is an optional coefficient. The above formula (1) is a formula using a property that radio field strength attenuates in inverse proportion to the square of distance. Note that the distance measurement unit 171 measures the distance a plurality of times (at least twice) at different timings.

The approach detection unit 172 detects that the mobile terminal 1 is approaching the wireless communication device 2a (in other words, the electronic money payment machine 3) on the basis of a distance measured by the distance measurement unit 171. For example, when a distance measured after a predetermined time (for example, several tens seconds) from a certain point of time is shorter than a distance measured at the certain point of time, the approach detection unit 172 detects that the mobile terminal 1 is approaching the wireless communication device 2a. The detection of approaching of the mobile terminal 1 to the wireless communication device 2a triggers an authorization request for a credit card payment (for example, the detection sets a trigger flag from 0 to 1). It is possible to reduce unnecessary authorization as much as possible by detecting that the mobile terminal 1 is approaching, and it is possible to reduce a processing load applied on the mobile terminal 1, the center server 4, and the credit card management server 5 due to the authorization. Alternatively, the approach detection unit 172 may detect that the mobile terminal 1 is approaching the wireless communication device 2a, when distances measured a predetermined number of times (for example, three to ten times) at a predetermined time interval (for example, 0.5 seconds) decrease as time passes. Therefore, it is possible to further reduce unnecessary authorization, and it is possible to reduce a processing load applied on the mobile terminal 1, the center server 4, and the credit card management server 5 due to the authorization. Here, an example of the distances measured a predetermined number of times decreasing as time passes includes distances continuously decreasing over a predetermined number of times (for example, three times), for example, 30 m→25 m→20 m . . . .

It should be noted that the approach detection unit 172 may calculate expected arrival time (for example, 10:00) at which the user carrying the mobile terminal 1 arrives at the electronic money payment machine 3, on the basis of a moving speed calculated on the basis of a difference between distances measured a plurality of times at different timings by the distance measurement unit 171 and a difference in measurement time, and the latest distance measured by the distance measurement unit 171 so as to detect that the mobile terminal 1 is approaching the wireless communication device 2a at a point of time (9:59) earlier by a necessary time (for example, one minute) required for authorization for a credit card payment, before the calculated expected arrival time. In other words, in a case where it is confirmed that the measured distances decrease as time passes, timing of detecting (the trigger flag is set from 0 to 1) that the mobile terminal 1 is approaching the wireless communication device 2a is not a point of time at which the confirmation is made but a point of time earlier by a necessary time before the expected arrival time (that is, detection is performed slightly later). Therefore, it is possible to further reduce unnecessary authorization, and it is possible to reduce a processing load applied on the mobile terminal 1, the center server 4, and the credit card management server 5 due to the authorization.

Here, the necessary time required for authorization is, for example, a time required from the transmission of an authorization request to the acquisition of a result of the authorization. For example, such necessary time is acquired from authorization history of previous authorization requests transmitted from the mobile terminal 1. The authorization history includes a predetermined time required from the transmission of an authorization request to the acquisition of an authorization result. Note that the authorization history may be stored in the storage unit 11 of the mobile terminal 1 or may be stored in a storage unit of the center server 4. Alternatively, the necessary time may be set to a default value as a time generally required for an authorization and stored in the storage unit 11. Furthermore, the moving speed corresponds to a walking speed of the user carrying the mobile terminal 1. For example, when a distance measured at measurement time t1 is d1 (m) and a distance measured at measurement time t2 is d2 (m), the moving speed r is calculated according to the following (2).

r=|d1−d2|/|t1−t2| (2)

Then, the expected arrival time is calculated by dividing the latest distance measured by the distance measurement unit 171 by the moving speed r.

The value balance determination unit 174 reads electronic value from the secure element 16 and determines whether an electronic value balance is equal to or smaller than a first threshold value (predetermined amount) or smaller than the first threshold value. Here, the first threshold value is set by the threshold value setting unit 173. For example, the threshold value setting unit 173 sets an amount specified by the user via the operation/display unit 12 as the first threshold value. Alternatively, the threshold value setting unit 173 may acquire payment amount information indicating a payment amount necessary for payment through payment through the electronic money payment machine 3 to set the payment amount indicated by the acquired payment amount information as the first threshold value.

The recharge amount determination unit 175 determines a recharge amount for automatic recharging. For example, the recharge amount determination unit 175 determines an amount specified by the user via the operation/display unit 12 as the recharge amount. Alternatively, the recharge amount determination unit 175 may acquire payment amount information indicating a payment amount necessary for payment through the electronic money payment machine 3 to determine, as the recharge amount, the payment amount (that is, the same amount as that of the first threshold value) indicated by the acquired payment amount information or an amount obtained by adding a preset amount to be added to the payment amount. Therefore, it is possible to determine the recharge amount so that the electronic value does not have an insufficient balance in electronic money payment which is made later. Alternatively, the recharge amount determination unit 175 may acquire payment amount information indicating a payment amount necessary for payment through the electronic money payment machine 3 to determine the recharge amount on the basis of the payment amount indicated by the acquired payment amount information and the electronic value balance. For example, when a payment amount is larger than an electronic value balance, an amount obtained by subtracting the electronic value balance from the payment amount (or an amount obtained by adding a preset amount to be added to the amount obtained by the subtraction) is determined as the recharge amount. In this way, it is possible to determine the minimum recharge amount required for the electronic money payment made later, in consideration of the electronic value balance.

The payment amount information used by the threshold value setting unit 173 and the recharge amount determination unit 175 is acquired from the radio signal received by the first short-range wireless communication unit 14, via the first short-range wireless communication unit 14. This makes it possible to quickly acquire the payment amount information indicating a payment amount necessary for payment through the electronic money payment machine 3. For example, payment amount information indicating a fixed amount of fare (payment amount) is acquired from a radio signal transmitted from a wireless communication device 2a by an electronic money payment machine 3 for payment of the fixed amount of fare of a specific vehicle (bus etc.). Alternatively, payment amount information indicating a fixed price (payment amount) may be acquired from a radio signal transmitted from a wireless communication device 2a by an electronic money payment machine 3 (for example, a vending machine) for payment of the fixed price of a specific merchandise item.

Alternatively, the threshold value setting unit 173 or the recharge amount determination unit 175 may identify a payment amount of electronic money paid in the past (for example, in the same time block in the past) through the same electronic money payment machine 3, from payment history data (that is, payment history of the user of the mobile terminal 1) stored in the secure element 16 so as to acquire payment amount information indicating the identified payment amount (an average value of a plurality of payment amounts identified). Therefore, even when the payment amount information cannot be acquired from the radio signal described above, it is possible to accurately acquire the payment amount necessary for payment through the electronic money payment machine 3. Note that it is determined whether the same electronic money payment machine 3 is selected by comparing, for example, the facility ID included in the radio signal with the facility ID included in the payment history data.

When it is detected by the approach detection unit 172 that the mobile terminal 1 is approaching the wireless communication device 2a, the authorization requesting unit 176 transmits a request for authorization for a credit card payment for a recharge amount determined by the recharge amount determination unit 175 to the center server 4 via the communication unit 13 and the network NW. Note that only when it is detected that an electronic value balance is equal to or smaller than the first threshold value or smaller than the first threshold value by the value balance determination unit 174 when approaching of the mobile terminal 1 to the wireless communication device 2a is detected, the authorization requesting unit 176 may transmit the request for authorization for a credit card payment for a recharge amount. In this case, even when approaching of the mobile terminal 1 to the wireless communication device 2a is detected, the authorization request is not transmitted when the electronic value balance is larger than the first threshold value. Thus, the authorization is permitted only when really required, for example, for preventing an insufficient balance, and a processing load applied on the mobile terminal 1, the center server 4, and the credit card management server 5 due to the authorization can be reduced.

The recharge/payment processing unit 177 has a function of a proxy agent for causing the applet of the secure element 16 to rewrite electronic value balance. When a credit approval is granted for an authorization made by the credit card management server 5 in response to the authorization request, the recharge/payment processing unit 177 performs recharge processing of recharging an electronic value balance with the recharge amount. In this recharge processing, for example, a recharge request is transmitted to perform automatic recharging with the recharge amount, but a detailed description will be made later. Furthermore, the recharge/payment processing unit 177 may perform payment processing for electronic money payment of a payment amount, after the recharge processing or at the same time as the recharge processing. Only when a credit approval is granted for the authorization and a distance measured by the distance measurement unit 171 is equal to or smaller than a second threshold value (predetermined distance) or smaller than the second threshold value, the recharge/payment processing unit 177 may perform the recharge processing of recharging an electronic value balance with the recharge amount. Thus, for example, only when the user carrying the mobile terminal 1 is close to the electronic money payment machine 3 and electronic money payment is likely to be made (for example, the user is likely to enter (pass through) a ticket gate of a station), recharge processing is performed, and a processing load applied on the mobile terminal 1, the electronic money payment machine 3, and the center server 4 caused by the recharge processing can be reduced.

Here, the second threshold value is set by the threshold value setting unit 173. For example, the threshold value setting unit 173 sets a distance designated by the user via the operation/display unit 12 as the second threshold value. Alternatively, the threshold value setting unit 173 may set the second threshold value larger as the moving speed calculated on the basis of a difference between distances measured a plurality of times at different timings by the distance measurement unit 171 and a difference in measurement time increases. The moving speed is calculated as described above. In this way, when the second threshold value is set larger as the moving speed increases (in other words, the second threshold value decreases as the moving speed decreases), the faster moving speed enables recharge processing at a position fully far from the electronic money payment machine 3, and recharging of electronic value with a recharge amount can be surely permitted before electronic money payment.

Alternatively, the threshold value setting unit 173 may identify the time (for example, 17:20) at which electronic money is paid through the electronic money payment machine 3 in the past, from payment history data (that is, payment history of the user of the mobile terminal 1) stored in the secure element 16 so as to set the second threshold value larger as an expected value of electronic money payment through the electronic money payment machine 3 in a time block (for example, time block of 17:00-18:00) including the identified time increases. Here, the time block has a preset width. Furthermore, the expected value is a value quantitatively indicating the level of possibility of electronic money payment in the corresponding time block. For example, when information about electronic money payment through the electronic money payment machine 3 in the time block is recorded in the payment history data, the expected value is determined as 1, and when not recorded, the expected value is determined as 0. Furthermore, when information about electronic money payment through the electronic money payment machine 3 in the time block over a plurality of days within a predetermined period (for example, one week) in the past is recorded in the payment history data, the expected value is determined as a value (for example, two days is determined as 2, three days as 3) depending on the number of days recorded. Still furthermore, when information about electronic money payment through the electronic money payment machine 3 in the time block is recorded in the payment history data, a predetermined value is further added to the determined expected value when a day of the week recorded matches a day of the week including the current time (that is, set time of the second threshold value). In this manner, when the second threshold value is set larger as the expected value of electronic money payment through the electronic money payment machine 3 increases (in other words, the second threshold value decreases as the expected value decreases), the larger expected value enables recharge processing at a position fully far from the electronic money payment machine 3, and recharge of electronic value with a recharge amount can be surely permitted before electronic money payment.

When electronic money payment of electronic value is not made within a predetermined time period after a credit approval is granted for an authorization made by the credit card management server 5, the credit approval cancellation requesting unit 178 transmits a request for cancellation of the credit approval (hereinafter referred to as “approval cancellation request”) to the center server 4 via the communication unit 13 and the network NW. Thus, it is possible to quickly cancel a secured recharge amount for which a credit approval is granted, restoring a previous available amount for credit card payment. Alternatively, when electronic money payment of electronic value is not made within a predetermined time period after the radio signal is not received by the first short-range wireless communication unit 14 after the credit approval is granted for the authorization made by the credit card management server 5, the credit approval cancellation requesting unit 178 may transmit the approval cancellation request to the center server 4 via the communication unit 13 and the network NW.

### [2. Operation of Electronic Payment System S]

Next, the operation of the electronic payment system S according to the present embodiment will be described in first to third examples.

### First Example

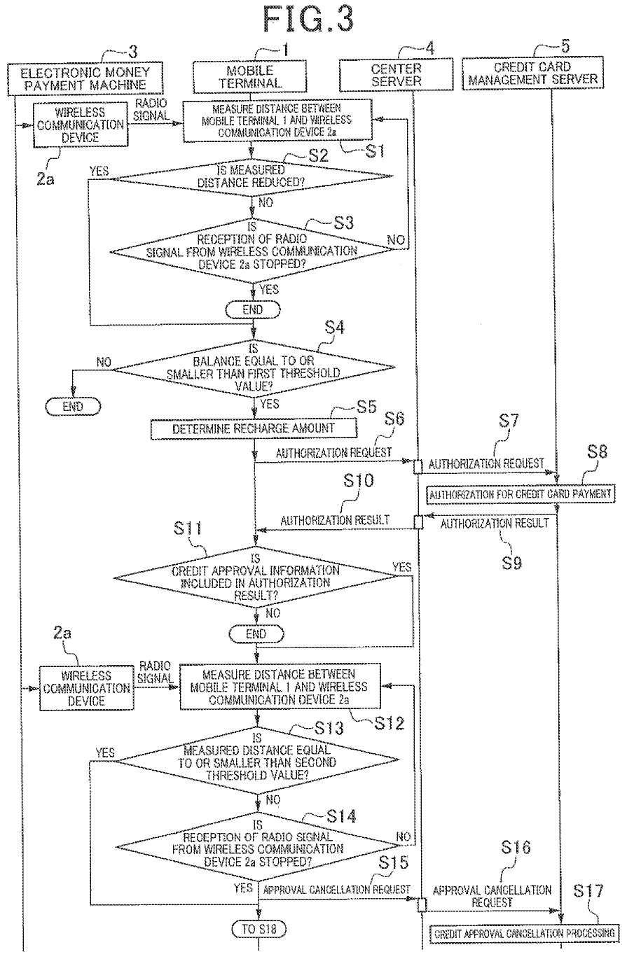

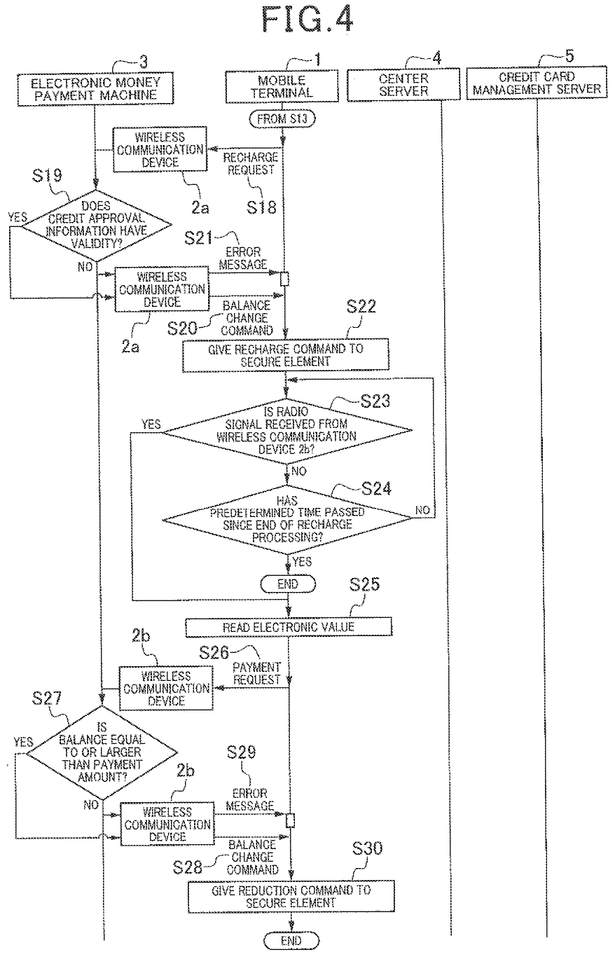

Firstly, the operation of the electronic payment system S according to a first example will be described with reference to FIGS. 3 and 4. The first example is an operation example where automatic recharging is performed through the electronic money payment machine 3 and then electronic money payment is made through the electronic money payment machine 3. FIGS. 3 and 4 are sequence diagrams each illustrating an operation example where automatic recharging is performed through the electronic money payment machine 3 and then electronic money payment is made through the electronic money payment machine 3. As described above, the mobile terminal 1 is within the wireless communication range of the wireless communication device 2a, a radio signal transmitted from the wireless communication device 2a is received by the first short-range wireless communication unit 14 of the mobile terminal 1. Data demodulated from the received radio signal is output to the control unit 17. Then, the control unit 17 of the mobile terminal 1 acquires the data output from the wireless communication device 2a, and acquires a radio field strength measured by the first short-range wireless communication unit 14, for example, when the data includes a bit sequence (for example, top several digits of the facility ID) previously registered. Then, as illustrated in FIG. 3, the control unit 17 of the mobile terminal 1 measures a distance between the mobile terminal 1 and the wireless communication device 2a on the basis of the acquired radio field strength (step S1). Note that the measured distance is recorded in chronological order in association with measurement time.

Next, the control unit 17 (the approach detection unit 172) of the mobile terminal 1 determines whether distances measured a plurality of times (measured distances) decreases as time passes (step S2). Note that the determination is not performed in step S2 upon the first distance measurement, and the process proceeds to step S3. When it is determined that the distances measured a plurality of times do not decrease as time passes (step S2: NO), the control unit 17 (the approach detection unit 172) proceeds to step S3. On the other hand, when it is determined that the distances measured a plurality of times decrease as time passes (step S2: YES), the control unit 17 (the approach detection unit 172) detects that the mobile terminal 1 is approaching the wireless communication device 2a (in other words, the electronic money payment machine 3) and proceeds to step S4.

When it is determined that the distances measured a plurality of times decrease as time passes (step S2: YES), the control unit 17 (the approach detection unit 172) may calculate the expected arrival time on the basis of the moving speed of the mobile terminal 1 and the latest distance as described above so as to determine whether a point of time earlier by a necessary time required for an authorization for a credit card payment before the calculated expected arrival time has come. In this case, when it is determined that the point of time earlier by a necessary time required for an authorization for a credit card payment before the expected arrival time has not come, the control unit 17 (the approach detection unit 172) returns to step S1. On the other hand, in this case, when it is determined that the point of time earlier by a necessary time required for an authorization for a credit card payment before the expected arrival time has come, the control unit 17 (the approach detection unit 172) detects that the mobile terminal 1 is approaching to the wireless communication device 2a, and proceeds to step S4.

In step S3, the control unit 17 of the mobile terminal 1 determines whether reception of the radio signal (radio signal including the same facility ID) from the wireless communication device 2a is interrupted for a predetermined time or more. When it is determined that the reception of the radio signal is interrupted for the predetermined time or more (step S3: YES), the control unit 17 finishes the process illustrated in FIG. 3. Thereafter, when the mobile terminal 1 is within the wireless communication range of the wireless communication device 2b, a general electronic money payment is made. On the other hand, when it is determined that the reception of the radio signal is not interrupted for the predetermined time or more (step S3: NO), the control unit 17 returns to step S1, and acquires a radio field strength newly measured to measure the distance between the mobile terminal 1 and the wireless communication device 2a on the basis of the acquired signal strength.

In step S4, the control unit 17 (the value balance determination unit 174) of the mobile terminal 1 reads electronic value from the secure element 16, and determines whether an electronic value balance is equal to or smaller than (or smaller than) the first threshold value. Here, as described above, the first threshold value is set by the threshold value setting unit 173 before the processing of step S4. When it is determined that the electronic value balance is equal to or smaller than (or smaller than) the first threshold value (step S4: YES), the control unit 17 (the value balance determination unit 174) proceeds to step S5. On the other hand, when it is determined that the electronic value balance is not equal to or smaller than the first threshold value (or not smaller than the first threshold value) (step S4: NO), the control unit 17 (the value balance determination unit 174) finishes the process illustrated in FIG. 3. Thereafter, when the mobile terminal 1 is within the wireless communication range of the wireless communication device 2b, a general electronic money payment is made.

In step S5, the control unit 17 (the recharge amount determination unit 175) of the mobile terminal 1 determines a recharge amount for automatic recharging, as described above. Note that the control unit 17 of the mobile terminal 1 may be configured to determine (balance confirmation) whether an electronic value balance is equal to or smaller than the first threshold value (or smaller than the first threshold value) not at the timing of step S4 but at the timing immediately after receiving the radio signal from the wireless communication device 2a, determine the recharge amount when the electronic value balance is equal to or smaller than the first threshold value (or smaller than the first threshold value), and then proceed to step S1. In this configuration, when the electronic value balance is not equal to or smaller than the first threshold value (or smaller than the first threshold value), the process illustrated in FIG. 3 is finished without proceeding to step S1.

Next, the control unit 17 (the authorization requesting unit 176) of the mobile terminal 1 reads information, such as a credit card number, credit card holder, credit card expiration date, from the secure element 16 and establishes a session with the center server 4 via the communication unit 13 and the network NW Then, the control unit 17 (the authorization requesting unit 176) of the mobile terminal 1 transmits an authorization request including the information read from the secure element 16, a recharge amount, a facility ID, and a session ID to the center server 4 via the communication unit 13 and the network NW (step S6). Here, the recharge amount is the recharge amount determined above. Furthermore, the facility ID is the facility ID acquired from the radio signal received by the first short-range wireless communication unit 14. Still furthermore, the session ID is identification information for identifying a session established with the center server 4 of the mobile terminal 1.

Upon receiving the authorization request from the mobile terminal 1, the center server 4 transmits the authorization request to the credit card management server 5 via the network NW or the dedicated line (step S7). Then, upon receiving the authorization request from the center server 4, the credit card management server 5 makes an authorization for a credit card payment for a recharge amount for recharging the electronic value balance, as described above (step S8). In the authorization, for example, when the credit card expiration date has not expired and the recharge amount does not exceed the available amount, the credit card management server 5 gives a credit approval and generates credit approval information including information, such as an approval date, approval amount, facility ID, and credit card number.

Furthermore, the credit card management server 5 stores credit history data including information, such as a transaction date, facility ID, and amount paid (recharge amount), for example, in the storage unit in association with the credit card number or the like. Note that, to the credit approval information, an electronic signature is added, for example, by using a private key of the credit card management server 5. On the other hand, when a credit approval is not granted for the authorization, the credit card management server 5 creates credit disapproval information indicating a disapproval of the authorization. Then, the credit card management server 5 returns an authorization result (including the generated credit approval information or credit disapproval information) to the center server 4 (step S9). Upon receiving the authorization result from the credit card management server 5, the center server 4 returns the authorization result to the mobile terminal 1 (step S10).

Upon receiving the authorization result from the center server 4 via the communication unit 13, the control unit 17 of the mobile terminal 1 determines whether the authorization result includes the credit approval information (that is, determines whether the credit approval is given) (step S11). When it is determined that the authorization result includes the credit approval information (step S11: YES), the control unit 17 proceeds to step S12. Note that the credit approval information is incorporated, for example, in credit card payment data and stored in the secure memory of the secure element 16. On the other hand, when it is determined that the credit approval information is not included in the authorization result (step S11: NO), the control unit 17 finishes the process illustrated in FIG. 3. Thereafter, when the mobile terminal 1 is within the wireless communication range of the wireless communication device 2b, a general electronic money payment is made.

In step S12, the control unit 17 of the mobile terminal 1 acquires a radio field strength measured by the first short-range wireless communication unit 14 and calculates a distance between the mobile terminal 1 and the wireless communication device 2a on the basis of the acquired signal strength. Next, the control unit 17 of the mobile terminal 1 determines whether the distance measured in step S12 is equal to or smaller than the second threshold value (or smaller than the second threshold value) (step S13). Here, as described above, the second threshold value is set by the threshold value setting unit 173 before the processing of step S12. When it is determined that the distance is not equal to or smaller than the second threshold value (or not smaller than the second threshold value) (step S13: NO), the control unit 17 proceeds to step S14. On the other hand, when it is determined that the distance is equal to or smaller than the second threshold value (or smaller than the second threshold value) (step S13: YES), the control unit 17 proceeds to step S18 illustrated in FIG. 4.

In step S14, the control unit 17 (the credit approval cancellation requesting unit 178) of the mobile terminal 1 determines whether reception of a radio signal (a radio signal including the same facility ID) from the wireless communication device 2a is interrupted for a predetermined time or more. When it is determined that the reception of the radio signal is not interrupted for the predetermined time or more (step S14: NO), the control unit 17 (the credit approval cancellation requesting unit 178) returns to step S12. On the other hand, when it is determined that the reception of the radio signal is interrupted for the predetermined time or more (step S14: YES), the control unit 17 (the credit approval cancellation requesting unit 178) establishes a session with the center server 4 via the communication unit 13 and the network NW and transmits an approval cancellation request to the center server 4 via the communication unit 13 and the network NW (step S15). That is, when electronic money payment of electronic value is not made within a predetermined time period after the radio signal is not received by the first short-range wireless communication unit 14 after credit approval is granted for the authorization, the approval cancellation request is transmitted to the center server 4. Note that this approval cancellation request includes, for example, the credit approval information included in the authorization result.

In another example, the control unit 17 (the credit approval cancellation requesting unit 178) of the mobile terminal 1 may determine whether electronic money payment of electronic value is made within a predetermined time period after the credit approval is granted for the authorization, without determining whether the reception of the radio signal is interrupted for the predetermined time or more. Then, when it is determined that the electronic money payment of the electronic value is not made within a predetermined time period after the credit approval is granted for the authorization, the control unit 17 (the credit approval cancellation requesting unit 178) may transmit the approval cancellation request to the center server 4 via the communication unit 13 and the network N.

Upon receiving the approval cancellation request from the mobile terminal 1, the center server 4 transmits the approval cancellation request to the credit card management server 5 via the network NW or the dedicated line (step S16). Then, upon receiving the approval cancellation request from the center server 4, the credit card management server 5 performs credit approval cancellation processing (step S17). In the credit approval cancellation processing, for example, information indicating cancellation of the credit approval is additionally recorded in credit history data corresponding to the credit approval information included in the approval cancellation request. When the credit approval cancellation processing is finished, information indicating completion of cancellation of the credit approval is transmitted from the credit card management server 5 to the mobile terminal 1 via the center server 4.

In step S18 illustrated in FIG. 4, the control unit 17 (the recharge/payment processing unit 177) of the mobile terminal 1 starts recharge processing and transmits a recharge request for automatic recharging with the determined recharge amount to the electronic money payment machine 3 via the first short-range wireless communication unit 14 and the wireless communication device 2a. The recharge request includes, for example, a recharge amount and the credit approval information. Note that before the transmission of the recharge request, the first short-range wireless communication unit 14 of the mobile terminal 1 transmits a connection request to the wireless communication device 2a in response to a command from the control unit 17, and a connection is established between the first short-range wireless communication unit 14 and the wireless communication device 2a.

Upon receiving the recharge request from the mobile terminal 1 via the wireless communication device 2a, the electronic money payment machine 3 verifies the credit approval information included in the recharge request, and determines whether the credit approval information has validity (step S19). This verification enables to prevent abuse of credit approval information due to, for example falsification or the like. Note that to this verification, various well-known methods can be applied. When it is determined that the credit approval information has validity (step S19: YES), the electronic money payment machine 3 starts automatic recharging, transmits a balance change command for adding the recharge amount included in the recharge request to the electronic value balance, to the mobile terminal 1 via the wireless communication device 2a (step S20), and stores recharge history data in a storage unit of the electronic money payment machine 3. Such recharge history data includes information, such as a recharge date, recharge amount, and credit approval information, for example. When the automatic recharging is performed in this way, billing data for the administration entity of the facility managing the electronic money payment machine 3 to charge the recharge amount is generated according to the recharge history data, and the billing data is transmitted to the credit card management server 5.

On the other hand, when it is determined that the credit approval information has no validity (step S19: NO), the electronic money payment machine 3 transmits an error message indicating the impossibility of recharging to the mobile terminal 1 via the wireless communication device 2a (step S21). The error message received by the mobile terminal 1 is displayed, for example, on the operation/display unit 12. Note that in a case where the abuse of the credit approval information can be prevented by another method, the electronic money payment machine 3 receiving the recharge request from the mobile terminal 1 may not perform the processing of step S19 described above and proceeds to step S20.

Upon receiving the balance change command (that is, a recharge command) from the electronic money payment machine 3 via the first short-range wireless communication unit 14, the control unit 17 (the recharge/payment processing unit 177) of the mobile terminal 1 gives the recharge command of the recharge amount indicated by the balance change command to the applet of the secure element 16 (step S22). Thus, the electronic value balance stored in the secure memory is recharged with the recharge amount. Furthermore, the control unit 17 (the recharge/payment processing unit 177) of the mobile terminal 1 causes the secure memory of the secure element 16 to store recharge history data including information, such as a recharge date, facility ID, and recharge amount. In this way, the control unit 17 (the recharge/payment processing unit 177) of the mobile terminal 1 finishes the recharge processing.

Next, the control unit 17 (the recharge/payment processing unit 177) of the mobile terminal 1 determines whether the radio signal from the wireless communication device 2b is received by the second short-range wireless communication unit 15 (step S23). This radio signal is, for example, a polling signal used by the electronic money payment machine 3 to detect a destination terminal. When it is determined that the radio signal from the wireless communication device 2b is not received (step S23: NO), the control unit 17 (the recharge/payment processing unit 177) of the mobile terminal 1 proceeds to step S24. On the other hand, when it is determined that the control unit 17 (the recharge/payment processing unit 177) of the mobile terminal 1 is within the wireless communication range of the wireless communication device 2b and receives the radio signal from the wireless communication device 2b (step S23: YES), the process proceeds to step S25.

In step S24, the control unit 17 of the mobile terminal 1 determines whether a predetermined time period (for example, several seconds) has passed since the end of the recharge processing. When it is determined that the predetermined time period has not passed since the end of the recharge processing (step S24: NO), the control unit 17 of the mobile terminal 1 returns to step S23. On the other hand, when it is determined that the predetermined time period has passed since the end of the recharge processing (step S24: YES), the control unit 17 of the mobile terminal 1 finishes the process illustrated in FIG. 4. The control unit 17 of the mobile terminal 1 may be configured to cancel the automatic recharging and the credit approval, when the predetermined time period has passed since the end of the recharge processing (that is, when the electronic money payment is not made even after the predetermined time period has passed since recharging with the recharge amount).

In step S25, after mutual authentication between the wireless communication device 2b and the second short-range wireless communication unit 15, the control unit 17 (the recharge/payment processing unit 177) of the mobile terminal 1 starts payment processing, and reads electronic value from the secure element 16. Then, the control unit 17 (the recharge/payment processing unit 177) of the mobile terminal 1 transmits a payment request for electronic money payment to the electronic money payment machine 3 via the second short-range wireless communication unit 15 and the wireless communication device 2b (step S26). This payment request includes information indicating information (that is, the electronic value balance recharged with the recharge amount) indicating the electronic value balance read in step S25.

Upon receiving the payment request from the mobile terminal 1 via the wireless communication device 2b, the electronic money payment machine 3 starts electronic money payment, and determines whether an electronic value balance indicated by the payment request is equal to or larger than a given payment amount (step S27). When it is determined that the electronic value balance is equal to or larger than the given payment amount (step S27: YES), the electronic money payment machine 3 transmits a balance change command for subtracting the payment amount from the electronic value balance, to the mobile terminal 1 via the wireless communication device 2b (step S28). On the other hand, when it is determined that the electronic value balance is not equal to or larger than the given payment amount (step S27: NO), the electronic money payment machine 3 transmits an error message indicating an insufficient balance to the mobile terminal 1 via the wireless communication device 2b (step S29). The error message received by the mobile terminal 1 is displayed, for example, on the operation/display unit 12.

Upon receiving the balance change command (that is, a subtraction command) from the electronic money payment machine 3, the control unit 17 (the recharge/payment processing unit 177) of the mobile terminal 1 gives the subtraction command for the payment amount indicated by the balance change command to the applet of the secure element 16 (step S30). Thus, the payment amount is reduced from the electronic value balance stored in the secure memory. Furthermore, the control unit 17 (the recharge/payment processing unit 177) of the mobile terminal 1 causes the secure memory of the secure element 16 to store the payment history data including information, such as a payment date, facility ID, payment amount or the like. In this way, the control unit 17 (the recharge/payment processing unit 177) of the mobile terminal 1 finishes the payment processing.

Note that in a case where the electronic money payment machine 3 verifies the credit approval information included in the recharge request in step S19 described above, the control unit 17 of the mobile terminal 1 receiving the authorization result from the center server 4 may advance the process to step S12 without performing the process of step S11 described above. In this case, the recharge request transmitted in step S18 includes the recharge amount and the authorization result. Then, when the credit approval information is included in the authorization result, the electronic money payment machine 3 verifies the credit approval information. However, even when the electronic money payment machine 3 verifies the credit approval information, no recharge request is transmitted when the credit disapproval information is included in the authorization result as a result of the processing of step S11 described above performed by the control unit 17 of the mobile terminal 1, and unnecessary processing of the electronic money payment machine 3 can be eliminated.

Furthermore, the control unit 17 of the mobile terminal 1 is configured to transmit the payment request to the electronic money payment machine 3 via the second short-range wireless communication unit 15 and the wireless communication device 2b, when receiving the radio signal from the wireless communication device 2b, in step S26, but in another example, the control unit 17 of the mobile terminal 1 may be configured to transmit the payment request to the electronic money payment machine 3 via the first short-range wireless communication unit 14 and the wireless communication device 2a, when a distance measured as described above is equal to or smaller than a third threshold value (or smaller than the third threshold value) which is smaller than the second threshold value, in step S26. In this case, the balance change command is transmitted from the electronic money payment machine 3 to the mobile terminal 1 via the wireless communication device 2a. Alternatively, when the mobile terminal 1 has a function of receiving a signal (for example, an infrared signal) from a human sensor (for example, an infrared sensor for opening/closing a gate) installed at a doorway of a facility (for example, a ticket gate at a station), the control unit 17 of the mobile terminal 1 may be configured to transmit the payment request to the electronic money payment machine 3 via the first short-range wireless communication unit 14 and the wireless communication device 2a upon receiving the signal from the human sensor, in step S26. The balance change command is transmitted from the electronic money payment machine 3 to the mobile terminal 1 via the wireless communication device 2a, also in this case.

According to the first example, after authorization for a credit card payment is made at more appropriate timing, an electronic value balance is surely recharged with a recharge amount, and electronic money payment is permitted.

### Second Example

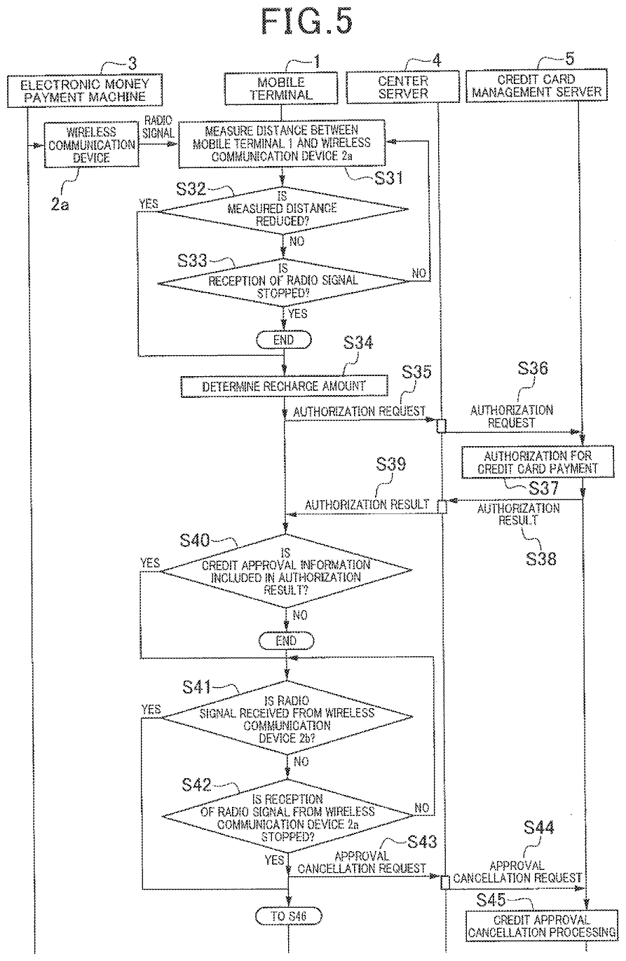

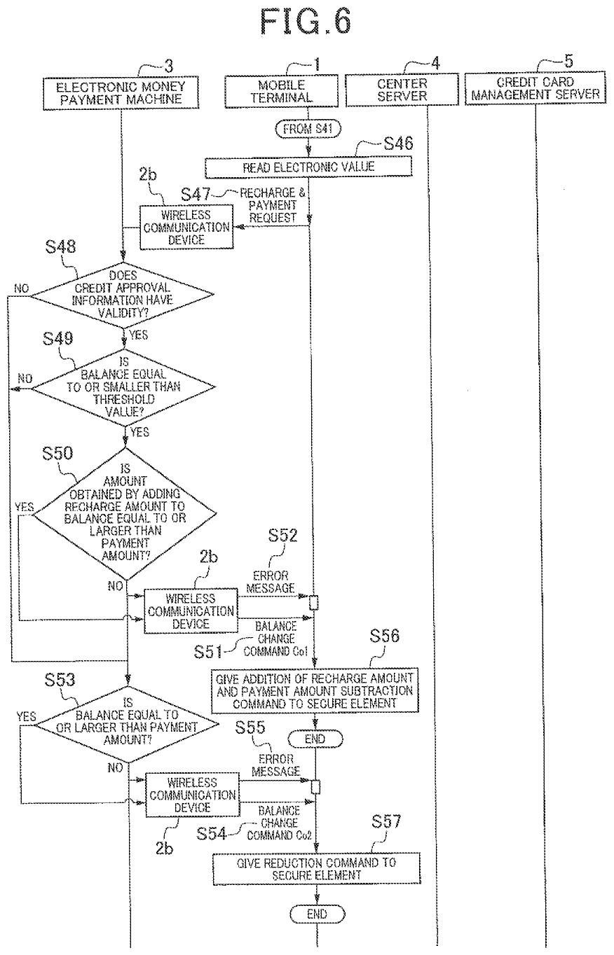

Next, the operation of the electronic payment system S according to a second example will be described with reference to FIGS. 5 and 6. The second example is an operation example of automatic recharging and electronic money payment simultaneously performed through the electronic money payment machine 3. FIGS. 5 and 6 are sequence diagrams each illustrating an operation example where automatic recharging and electronic money payment are simultaneously performed through the electronic money payment machine 3. Note that the processing of steps S31 to S33 illustrated in FIG. 5 is similar to the processing of steps S1 to S3 illustrated in FIG. 3.

In step S34, the control unit 17 (the recharge amount determination unit 175) of the mobile terminal 1 determines a recharge amount for automatic recharging, as described above. Note that the control unit 17 of the mobile terminal 1 may be configured to determine the recharge amount not at the timing of step S34 described above but at the timing, for example, immediately after reception of a radio signal from the wireless communication device 2a and proceed to step S31. In the second example, as described later, the electronic money payment machine 3 is configured to perform balance confirmation, but, as in the first example, the control unit 17 of the mobile terminal 1 may perform the balance confirmation.

Note that the processing of steps S35 to S39 illustrated in FIG. 5 is similar to the processing of steps S6 to S10 illustrated in FIG. 3.

Step S40 is similar to step S11 illustrated in FIG. 3, and upon receiving the authorization result from the center server 4 via the communication unit 13, the control unit 17 of the mobile terminal 1 determines whether the authorization result includes the credit approval information. When it is determined that the authorization result includes the credit approval information (step S40: YES), the control unit 17 proceeds to step S41. On the other hand, when it is determined that the credit approval information is not included in the authorization result (step S40: NO), the control unit 17 finishes the process illustrated in FIG. 5. Thereafter, when the mobile terminal 1 is within the wireless communication range of the wireless communication device 2b, a general electronic money payment is made.

In step S41, the control unit 17 (the recharge/payment processing unit 177) of the mobile terminal 1 determines whether a radio signal from the wireless communication device 2b is received by the second short-range wireless communication unit 15. This radio signal is, for example, a polling signal used by the electronic money payment machine 3 to detect a destination terminal. When it is determined that the radio signal from the wireless communication device 2b is not received (step S41: NO), the control unit 17 (the recharge/payment processing unit 177) of the mobile terminal 1 proceeds to step S42. On the other hand, when it is determined that the control unit 17 (the recharge/payment processing unit 177) of the mobile terminal 1 is within the wireless communication range of the wireless communication device 2b and receives the radio signal from the wireless communication device 2b (step S41: YES), the process proceeds to step S46.

Note that the processing of steps S42 to S45 illustrated in FIG. 5 is similar to the processing of steps S14 to S17 illustrated in FIG. 3.

In step S46 illustrated in FIG. 6, after mutual authentication between the wireless communication device 2b and the second short-range wireless communication unit 15, the control unit 17 (the recharge/payment processing unit 177) of the mobile terminal 1 starts recharge processing and payment processing, and reads electronic value from the secure element 16. Then, the control unit 17 (the recharge/payment processing unit 177) of the mobile terminal 1 transmits a recharge & payment request in which the recharge request and the payment request are integrated, to the electronic money payment machine 3 via the second short-range wireless communication unit 15 and the wireless communication device 2b (step S47). This recharge & payment request includes information indicating the determined recharge amount, credit approval information, and an electronic value balance. Note that, the recharge & payment request may include the first threshold value set by the threshold value setting unit 173.

Upon receiving the recharge & payment request from the mobile terminal 1 via the wireless communication device 2b, the electronic money payment machine 3 verifies the credit approval information included in the recharge & payment request, and determines whether the credit approval information has validity (step S48). When it is determined that the credit approval information has validity (step S48: YES), the electronic money payment machine 3 proceeds to step S49. On the other hand, when it is determined that the credit approval information has no validity (step S48: NO), the electronic money payment machine 3 starts electronic money payment without performing automatic recharging and proceeds to step S53. Note that in a case where the abuse of the credit approval information can be prevented by another method, the electronic money payment machine 3 receiving the recharge & payment request from the mobile terminal 1 may not perform the processing of step S48 described above and advance the process to step S49.

In step S49, the electronic money payment machine 3 determines whether the electronic value balance indicated by the recharge & payment request is equal to or smaller than a threshold value (or smaller than the threshold value). Here, the threshold value may be the first threshold value set by the threshold value setting unit 173 or may be any appropriate value set by an administration entity of a facility where the electronic money payment machine 3 is installed. When it is determined that the electronic value balance is equal to or smaller than the threshold value (or smaller than the threshold value) (step S49: YES), the electronic money payment machine 3 starts automatic recharging and electronic money payment and proceeds to step S50. On the other hand, when it is determined that the electronic value balance is not equal to or smaller than the threshold value (or not smaller than the threshold value) (that is, the electronic value balance is sufficient) (step S49: NO), the electronic money payment machine 3 starts the electronic money payment without performing automatic recharging and proceeds to step S53.

In step S50, the electronic money payment machine 3 determines whether an amount obtained by adding the recharge amount to the electronic value balance is equal to or larger than a given payment amount. When it is determined that an amount obtained by adding a recharge amount to the electronic value balance is equal to or larger than the given payment amount (step S50: YES), the electronic money payment machine 3 transmits a balance change command Co1 for adding the recharge amount to the electronic value balance and subtracting the payment amount therefrom, to the mobile terminal 1 via the wireless communication device 2b (step S51), and stores recharge history data in the storage unit of the electronic money payment machine 3. Such recharge history data includes information, such as a recharge date, recharge amount, and credit approval information, for example. When the automatic recharging is performed in this way, billing data for the administration entity of the facility managing the electronic money payment machine 3 to charge the recharge amount is generated according to the recharge history data, and the billing data is transmitted to the credit card management server 5.

On the other hand, when it is determined that the amount obtained by adding a recharge amount to the electronic value balance is not equal to or larger than the given payment amount (step S50: NO), the electronic money payment machine 3 transmits an error message indicating an insufficient balance to the mobile terminal 1 via the wireless communication device 2b (step S52). The error message received by the mobile terminal 1 is displayed, for example, on the operation/display unit 12.

In step S53, the electronic money payment machine 3 determines whether the electronic value balance indicated by the recharge & payment request is equal to or larger than the given payment amount. When it is determined that the electronic value balance is equal to or larger than the given payment amount (step S53: YES), the electronic money payment machine 3 transmits a balance change command Co2 for subtracting the payment amount from the electronic value balance, to the mobile terminal 1 via the wireless communication device 2b (step S54). On the other hand, when it is determined that the electronic value balance is not equal to or larger than the given payment amount (step S53: NO), the electronic money payment machine 3 transmits an error message indicating an insufficient balance to the mobile terminal 1 via the wireless communication device 2b (step S55).

Upon receiving the balance change command Co1 from the electronic money payment machine 3, the control unit 17 (the recharge/payment processing unit 177) of the mobile terminal 1 gives a command for adding the recharge amount and subtracting the payment amount indicated by the balance change command Co1, to the applet of the secure element 16 (step S56). Thus, the payment amount is subtracted from the amount obtained by adding a recharge amount to the electronic value balance. On the other hand, upon receiving the balance change command Co2 from the electronic money payment machine 3, the control unit 17 (the recharge/payment processing unit 177) of the mobile terminal 1 gives a subtraction command for the payment amount indicated by the balance change command Co2 to the applet of the secure element 16 (step S57). Thus, the payment amount is reduced from the electronic value balance stored in the secure memory.

Note that in a case where the electronic money payment machine 3 verifies the credit approval information included in the recharge & payment request in step S48 described above, the control unit 17 of the mobile terminal 1 receiving the authorization result from the center server 4 may advance the process to step S41 without performing the process of step S40 described above, as in the first example. Furthermore, the control unit 17 of the mobile terminal 1 is configured to transmit the recharge & payment request to the electronic money payment machine 3 via the second short-range wireless communication unit 15 and the wireless communication device 2b, when receiving the radio signal from the wireless communication device 2b, in step S47, but, as in the first example, the control unit 17 of the mobile terminal 1 may be configured so that the recharge & payment request is transmitted to the electronic money payment machine 3 via the first short-range wireless communication unit 14 and the wireless communication device 2a, when a measured distance is equal to or smaller than the third threshold value (or smaller than the third threshold value), in step S47. Alternatively, as in the first example, the control unit 17 of the mobile terminal 1 may be configured so that the recharge & payment request is transmitted to the electronic money payment machine 3 via the first short-range wireless communication unit 14 and the wireless communication device 2a, when a signal from the human sensor is received, in step S47.

According to the second example, after authorization for a credit card payment is made at more appropriate timing, electronic money payment and recharging of an electronic value balance with a recharge amount are simultaneously performed, and the recharge amount added for recharging can be efficiently used for an electronic money payment.

### Third Example

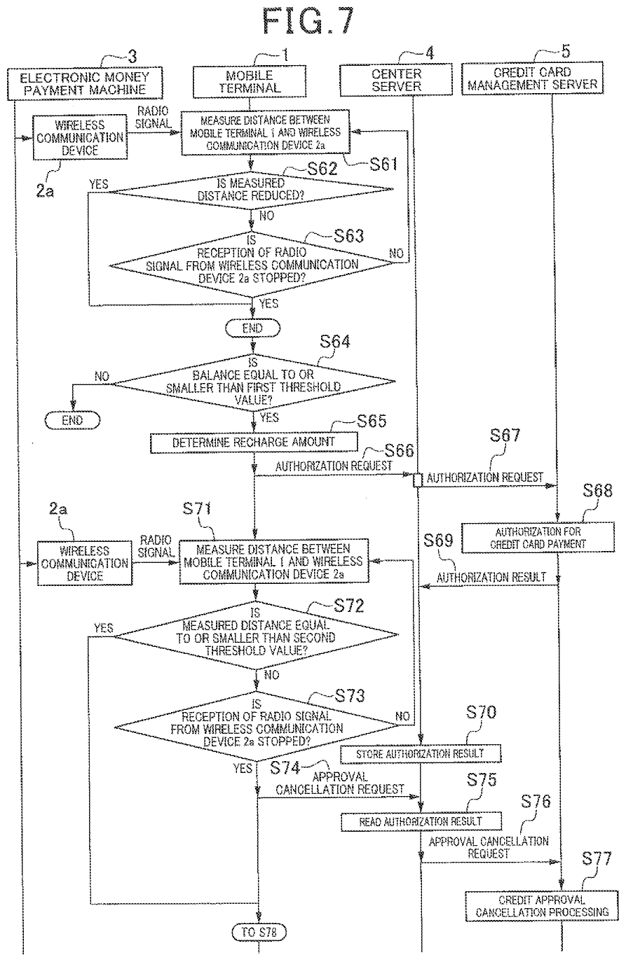

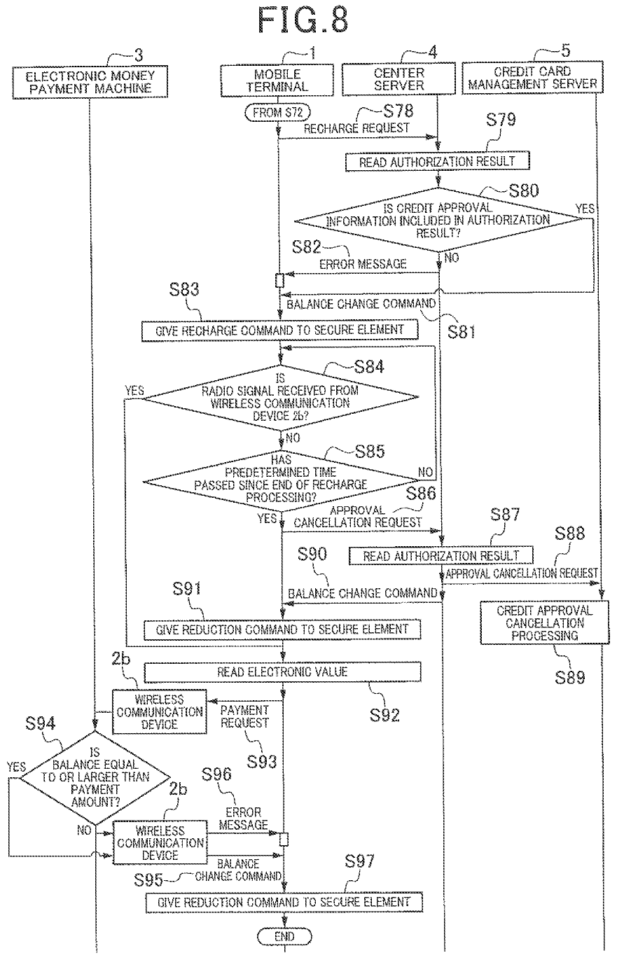

Next, the operation of the electronic payment system S according to a third example will be described with reference to FIGS. 7 and 8. The third example is an operation example where automatic recharging is performed by the center server 4 and then electronic money payment is made through the electronic money payment machine 3. FIGS. 7 and 8 are sequence diagrams each illustrating an operation example where automatic recharging is performed by the center server 4 and then electronic money payment is made through the electronic money payment machine 3. Note that the processing of steps S61 to S69 illustrated in FIG. 7 is similar to the processing of steps S1 to S9 illustrated in FIG. 3. However, in the third example, the authorization request includes terminal specific information, in addition to the credit card number, credit card holder, credit card expiration date, recharge amount, facility ID, and session ID. An example of the terminal specific information includes, for example, a telephone number of the mobile terminal 1, a user ID of the user of the mobile terminal 1, a secure ID stored in the secure element 16 of the mobile terminal 1, a credit card number, or the like.

In step S70, upon receiving an authorization result from the credit card management server 5, the center server 4 stores the authorization result in a storage unit in association with the mobile terminal specific information and the session ID which are included in the authorization request. This authorization result is held for a certain period of time.

After transmitting the authorization request in step S66, the control unit 17 of the mobile terminal 1 acquires a radio field strength measured by the first short-range wireless communication unit 14 in step S71, and calculates a distance between the mobile terminal 1 and the wireless communication device 2a on the basis of the acquired radio field strength. Next, the control unit 17 of the mobile terminal 1 determines whether the distance measured in step S71 is equal to or smaller than the second threshold value (or smaller than the second threshold value) (step S72). Here, as described above, the second threshold value is set by the threshold value setting unit 173 before the processing of step S71. When it is determined that the distance is not equal to or smaller than the second threshold value (or not smaller than the second threshold value) (step S72: NO), the control unit 17 proceeds to step S73. On the other hand, when it is determined that the distance is equal to or smaller than the second threshold value (or smaller than the second threshold value) (step S72: YES), the control unit 17 proceeds to step S78 illustrated in FIG. 8.

In step S73, the control unit 17 (the credit approval cancellation requesting unit 178) of the mobile terminal 1 determines whether reception of a radio signal (a radio signal including the same facility ID) from the wireless communication device 2a is interrupted for a predetermined time or more. When it is determined that the reception of the radio signal is not interrupted for the predetermined time or more (step S73: NO), the control unit 17 (the credit approval cancellation requesting unit 178) returns to step S71. On the other hand, when it is determined that the reception of the radio signal is interrupted for the predetermined time or more (step S73: YES), the control unit 17 (the credit approval cancellation requesting unit 178) transmits an approval cancellation request to the center server 4 via the communication unit 13 and the network NW (step S74). Note that this approval cancellation request includes, for example, the mobile terminal specific information and the session ID included in the authorization request.

Upon receiving the approval cancellation request from the mobile terminal 1, the center server 4 reads the terminal specific information included in the approval cancellation request and the authorization result associated with the session ID, from the storage unit (step S75), and transmits the approval cancellation request including the read authorization result to the credit card management server 5 via the network NW or the dedicated line (step S76).

Upon receiving the approval cancellation request from the center server 4, the credit card management server 5 performs credit approval cancellation processing (step S77). In the credit approval cancellation processing, for example, when the credit approval information is included in the authorization result included in the approval cancellation request, information indicating cancellation of the credit approval is additionally recorded in credit history data corresponding to the credit approval information. When the credit approval cancellation processing is finished, information indicating completion of cancellation of the credit approval is transmitted from the credit card management server 5 to the mobile terminal 1 via the center server 4.

In step S78 illustrated in FIG. 8, the control unit 17 (the recharge/payment processing unit 177) of the mobile terminal 1 starts recharge processing and transmits a recharge request for automatic recharging with the determined recharge amount (for example, including terminal specific information and recharge amount) to the center server 4 via the communication unit 13 and the network N.

Upon receiving the recharge request from the mobile terminal 1, the center server 4 reads the terminal specific information included in the recharge request and the authorization result associated with the session ID, from the storage unit (step S79), and determines whether the authorization result includes the credit approval information (that is, whether the credit approval is granted) (step S80). When it is determined that the credit approval information is included in the authorization result (step S80: YES), the center server 4 starts automatic recharging, transmits a balance change command for adding the recharge amount included in the recharge request to an electronic value balance, to the mobile terminal 1 via the network NW (step S81), and stores recharge history data in the storage unit of the center server 4. Such recharge history data includes information, such as a recharge date, recharge amount, mobile terminal specific information, session ID, and credit approval information, for example. When the automatic recharging is performed in this way, billing data for an administration entity managing the center server 4 to charge the recharge amount is generated according to the recharge history data, and the billing data is transmitted to the credit card management server 5.

On the other hand, when it is determined that the credit approval information is not included in the authorization result (step S80: NO), the control unit 17 transmits an error message indicating the impossibility of recharging to the mobile terminal 1 via the network NW (step S82). The error message received by the mobile terminal 1 is displayed, for example, on the operation/display unit 12.

Upon receiving the balance change command from the center server 4 via the communication unit 13, the control unit 17 (the recharge/payment processing unit 177) of the mobile terminal 1 gives a recharge command of the recharge amount indicated by the balance change command to the applet of the secure element 16 (step S83). Thus, the electronic value balance stored in the secure memory is recharged with the recharge amount. Furthermore, the control unit 17 (the recharge/payment processing unit 177) of the mobile terminal 1 causes the secure memory of the secure element 16 to store recharge history data including information, such as a recharge date, facility ID, and recharge amount. In this way, the control unit 17 (the recharge/payment processing unit 177) of the mobile terminal 1 finishes the recharge processing.

Next, the control unit 17 (the recharge/payment processing unit 177) of the mobile terminal 1 determines whether the radio signal from the wireless communication device 2b is received by the second short-range wireless communication unit 15 (step S84). When it is determined that the radio signal from the wireless communication device 2b is not received (step S84: NO), the control unit 17 (the recharge/payment processing unit 177) of the mobile terminal 1 proceeds to step S85. On the other hand, when it is determined that the control unit 17 (the recharge/payment processing unit 177) of the mobile terminal 1 is within the wireless communication range of the wireless communication device 2b and receives the radio signal from the wireless communication device 2b (step S84: YES), the process proceeds to step S92.

In step S85, the control unit 17 of the mobile terminal 1 determines whether a predetermined time period (for example, several seconds) has passed since the end of the recharge processing. When it is determined that the predetermined time period has not passed since the end of the recharge processing (step S85: NO), the control unit 17 of the mobile terminal 1 returns to step S84. On the other hand, when it is determined that the predetermined time period has passed since the end of the recharge processing (step S85: YES), the control unit 17 of the mobile terminal 1 establishes a session with the center server 4 via the communication unit 13 and the network NW and transmits an approval and recharge cancellation request to the center server 4 via the communication unit 13 and the network NW (step S86). In other words, when electronic money payment is not made from the electronic value recharged with the recharge amount within a predetermined time period after the electronic value balance is recharged with the recharge amount, the approval and recharge cancellation request is transmitted to the center server 4. Note that, the approval and recharge cancellation request includes, for example, the mobile terminal specific information and the session ID included in the authorization request.

Upon receiving the approval and recharge cancellation request from the mobile terminal 1, the center server 4 reads the terminal specific information included in the approval and recharge cancellation request and the authorization result associated with the session ID, from the storage unit (step S87), and transmits an approval cancellation request including the read authorization result to the credit card management server 5 via the network NW or the dedicated line (step S88). Upon receiving the approval cancellation request from the center server 4, the credit card management server 5 performs credit approval cancellation processing (step S89) as in step S77 described above.

After transmitting the approval cancellation request in step S88, the center server 4 performs recharge cancellation processing. In this recharge cancellation processing, for example, information indicating cancellation of recharging with the recharge amount is additionally recorded in credit history data corresponding to the terminal specific information and session ID included in the approval and recharge cancellation request (that is, credit history data including the terminal specific information and the session ID). Next, the center server 4 transmits a balance change command (that is, a recharge cancellation command) for subtracting the recharge amount added for recharging, to the mobile terminal 1 via the network NW (step S90).

Upon receiving the balance change command (that is, the recharge cancellation command) from the center server 4 via the communication unit 13, the control unit 17 (the recharge/payment processing unit 177) of the mobile terminal 1 gives a subtraction command for the recharge amount indicated by the balance change command to the applet of the secure element 16 (step S91). Thus, the recharge amount is reduced from the electronic value balance stored in the secure memory (that is, recharging with the recharge amount is canceled).

Note that the processing of steps S92 to S97 illustrated in FIG. 8 is similar to the processing of steps S25 to S30 illustrated in FIG. 4. Furthermore, the control unit 17 of the mobile terminal 1 is configured to transmit the payment request to the electronic money payment machine 3 via the second short-range wireless communication unit 15 and the wireless communication device 2b, when receiving the radio signal from the wireless communication device 2b, in step S93, but, as in the first example, the control unit 17 of the mobile terminal 1 may be configured so that the payment request is transmitted to the electronic money payment machine 3 via the first short-range wireless communication unit 14 and the wireless communication device 2a, when a measured distance is equal to or smaller than the third threshold value (or smaller than the third threshold value), in step S93. Alternatively, as in the first example, the control unit 17 of the mobile terminal 1 may be configured so that the payment request is transmitted to the electronic money payment machine 3 via the first short-range wireless communication unit 14 and the wireless communication device 2a, when a signal from the human sensor is received, in step S93.

According to the third example, after authorization for a credit card payment is made at more appropriate timing, an electronic value balance is surely recharged with a recharge amount, and an electronic money payment is permitted. Furthermore, since a recharge amount is added for recharging by the center server 4, the present invention is easily applied to an existing electronic payment system and permits easy cancellation of a credit approval and recharging.

### (First Modification)

Next, a first modification of the first to third examples will be described. In the first modification, it is assumed that an electronic payment system for a station is configured so that, in a case where the electronic money payment machine 3 is installed at a ticket gate of a station (railroad station), when the user of the mobile terminal 1 enters a ticket gate of station A, an entry record is made in the secure element 16 but no payment amount (for example, minimum fare) is reduced from an electronic value balance, and when the user of the mobile terminal 1 leaves a ticket gate of station B, a payment amount (for example, a rail zone fare) is subtracted from the electronic value balance.

In a case where the first example is applied to such an electronic payment system, the electronic money payment machine 3 receiving a payment request (payment request transmitted in step S26 described above) from the mobile terminal 1 when the user of the mobile terminal 1 enters the ticket gate of station A determines whether an electronic value balance indicated by the payment request is equal to or larger than a payment amount (for example, the minimum fare) necessary for payment through the electronic money payment machine 3. Then, when it is determined that the electronic value balance is equal to or larger than a given payment amount (step S27: YES), the electronic money payment machine 3 transmits not the balance change command but an entry record command to the mobile terminal 1 via the wireless communication device 2b in step S28. Thus, in the secure element 16 of the mobile terminal 1, the station name or the like (an example of the facility ID) of station A which the user has entered is recorded (entry record).

Thereafter, when it is detected that the mobile terminal 1 is approaching the wireless communication device 2a by the control unit 17 (the approach detection unit 172) while the user of the mobile terminal 1 goes to a ticket gate of station B, the control unit 17 acquires a station name (example of a facility ID) of station B from a radio signal transmitted from the wireless communication device 2a at the ticket gate of station B. Then, the control unit 17 identifies a rail zone on the basis of the recorded station name of station A and the acquired station name of station B, and the fare in the rail zone, and acquires payment amount information indicating the fare as payment amount information indicating a payment amount necessary for payment through the electronic money payment machine 3 installed at the ticket gate of station B. Note that the fare in the rail zone can be searched for from, for example, an application installed in the mobile terminal 1 or a predetermined server with the rail zone as a key.

The fare indicated by the payment amount information thus acquired is used in steps S4 and S5. That is, in step S4, the control unit 17 (the value balance determination unit 174) of the mobile terminal 1 determines whether the electronic value balance is equal to or smaller than the fare (or smaller than the fare) as the first threshold value, and when it is determined that the electronic value balance is equal to or smaller than the fare (or smaller than the fare) (step S4: YES), the process proceeds to step S5. In step S5, the control unit 17 (the recharge amount determination unit 175) of the mobile terminal 1 determines, as a recharge amount, the fare indicated by the payment amount information or an amount obtained by adding a preset amount to be added to the fare. Alternatively, the control unit 17 (the recharge amount determination unit 175) of the mobile terminal 1 determines, as the recharge amount, an amount obtained by subtracting an electronic value balance from the fare (or an amount obtained by adding a preset amount to be added to the amount obtained by subtraction).

Then, the processing of step S6 and subsequent steps is performed, and the electronic money payment machine 3 receiving a payment request (payment request transmitted in step S26 described above) from the mobile terminal 1 when the user of the mobile terminal 1 leaves the ticket gate of station B determines whether an electronic value balance indicated by the payment request is equal to or larger than a payment amount (that is, the rail zone fare) necessary for payment through the electronic money payment machine 3 (step S27). Then, when it is determined that the electronic value balance is equal to or larger than the payment amount (step S27: YES), the electronic money payment machine 3 transmits a balance change command for subtracting the payment amount from the electronic value balance, to the mobile terminal 1 via the wireless communication device 2b. The first modification may also be applied to the second example or the third example.

According to the first modification, even in a payment system for a station as described above, after authorization for a credit card payment is made at more appropriate timing, an electronic value balance is effectively recharged with a recharge amount.

Note that a system may be configured so that in a case where the electronic money payment machine 3 is installed at a ticket gate of a station, when the user of the mobile terminal 1 enters a ticket gate of station A, the minimum fare is reduced from an electronic value balance, and when the user of the mobile terminal 1 leaves a ticket gate of station B, “a difference between a rail zone fare and the minimum fare” is subtracted from the electronic value balance. In this case, while the user of the mobile terminal 1 getting off a train at station B moves to the ticket gate, and after the mobile terminal 1 approaching the wireless communication device 2a is detected by the control unit 17 (the approach detection unit 172), the control unit 17 desirably identifies the fare being a difference between a rail zone fare and the minimum fare and acquires payment amount information indicating the fare as payment amount information indicating a payment amount necessary for payment through the electronic money payment machine 3 installed at the ticket gate of station B.

### (Second Modification)

Next, a second modification of the first to third examples will be described. In the second modification, it is assumed that an electronic payment system having a plurality of electronic money payment machines 3 installed at different places. For example, it is assumed that an electronic money payment machine 3x and an electronic money payment machine 3y are installed at different places, and the mobile terminal 1 makes a payment with either one of the electronic money payment machine 3x and the electronic money payment machine 3y. For example, it is assumed that the electronic money payment machine 3x and the electronic money payment machine 3y are installed at an interval of several tens meters in the moving direction of the user carrying the mobile terminal 1, and the user moves to any of the electronic money payment machines. Here, each of the electronic money payment machines 3x and 3y has the same function as the above-described electronic money payment machine 3. Then, wireless communication devices 2ax and 2bx are integrally or separately provided to be connected to the electronic money payment machine 3x, and wireless communication devices 2ay and 2by are integrally or separately provided to be connected to the electronic money payment machine 3y. The wireless communication devices 2ax and 2ay are configured to have the same function as the wireless communication device 2a described above, and the wireless communication devices 2bx and 2by are configured to have the same function as the wireless communication device 2b described above.

In a case where the first example is applied to such an electronic payment system, it is assumed that when the mobile terminal 1 receives a radio signal transmitted from the wireless communication device 2ax connected to the electronic money payment machine 3x, the processing of step S1 and subsequent steps described above is performed, and the mobile terminal 1 further receives a radio signal transmitted from the wireless communication device 2ay connected to the electronic money payment machine 3y, during a period from receiving an authorization result (including credit approval information) from the center server 4 (that is, after a credit approval is granted) before performing automatic recharging. In this case, the processing of step S1 and subsequent steps is performed for the electronic money payment machine 3y (that is, processing for the electronic money payment machine 3y is performed in parallel with the current processing), but in step S5, when a recharge amount for the current authorization is determined, the control unit 17 of the mobile terminal 1 determines whether the determined recharge amount is larger than a recharge amount for which a credit approval is granted for the previous authorization (that is, the recharge amount determined in a process of communication with the wireless communication device 2ax connected to the electronic money payment machine 3x).

Note that such a determination is preferably made only when a facility ID included in the radio signal transmitted from the wireless communication device 2ax and a facility ID included in the radio signal transmitted from the wireless communication device 2ay are the same or relevant to each other. Here, examples of the relevance of both facility IDs include facility IDs which have an identical predetermined digit, and facility IDs which are registered in association with each other in a related list previously obtained.

Then, when the recharge amount for this current authorization is larger than the recharge amount for which a credit approval is granted for the previous authorization, the control unit 17 of the mobile terminal 1 transmits the authorization request to the center server 4 via the communication unit 13 and the network NW in step S6. Therefore, when the processing of step S7 and subsequent steps is performed and an authorization result including credit approval information is obtained, the already obtained credit approval information (that is, the credit approval information obtained in the process of communication with the wireless communication device 2ax connected to the electronic money payment machine 3x) is discarded. In this case, even when the distance between the mobile terminal 1 and the wireless communication device 2ax (the electronic money payment machine 3x) is equal to or smaller than the second threshold value (or smaller than the second threshold value) or the distance between the mobile terminal 1 and the wireless communication device 2ay (the electronic money payment machine 3y) is equal to or smaller than the second threshold value (or smaller than the second threshold value), the credit approval information obtained later (that is, the credit approval information obtained in a process of communication with the wireless communication device 2ay connected to the electronic money payment machine 3y) is used. That is, in step S18, the control unit 17 of the mobile terminal 1 transmits a recharge request including the credit approval information obtained later, to the electronic money payment machine 3 via the first short-range wireless communication unit 14 and the wireless communication device 2a.

On the other hand, when the recharge amount for this current authorization is equal to or smaller than the recharge amount for which a credit approval is granted for the previous authorization, the control unit 17 of the mobile terminal 1 does not transmit the authorization request described above. In this case, even when the distance between the mobile terminal 1 and the wireless communication device 2ax (the electronic money payment machine 3x) is equal to or smaller than the second threshold value (or smaller than the second threshold value) or the distance between the mobile terminal 1 and the wireless communication device 2ay (the electronic money payment machine 3y) is equal to or smaller than the second threshold value (or smaller than the second threshold value), the credit approval information having been obtained (that is, the credit approval information obtained in the process of communication with the wireless communication device 2ax connected to the electronic money payment machine 3x) is used. That is, in step S18, the control unit 17 of the mobile terminal 1 transmits a recharge request including the credit approval information having been obtained, to the electronic money payment machine 3 via the first short-range wireless communication unit 14 and the wireless communication device 2a. The second modification may also be applied to the second example or the third example. Furthermore, the second modification can also be applied to a case where three or more electronic money payment machines 3 are installed in different places.

According to the second modification, in the electronic payment system having a plurality of electronic money payment machines 3 installed at different places, authorization requests are prevented from being repeatedly transmitted to the center server 4 and the credit card management server 5 in the same time block, and it is possible to reduce a processing load applied on the mobile terminal 1, the center server 4, and the credit card management server 5 due to the authorization.

As described above, the mobile terminal 1 measures a distance between the mobile terminal 1 and a wireless communication device 2a on the basis of a radio signal transmitted from the wireless communication device 2a connected to an electronic money payment machine, and the mobile terminal 1 transmits an authorization request for a credit card payment of a recharge amount for recharging an electronic value balance to a center server 4 when detecting, on the basis of the measured distance, that the mobile terminal 1 is approaching the wireless communication device 2a and performs processing of permitting recharge of the electronic value balance with the recharge amount when a credit approval is granted for the authorization according to the authorization request. Thus, after authorization for a credit card payment is made at more appropriate timing, an electronic value balance is recharged with a recharge amount.

In the above embodiments, instead of the electronic money payment machine 3, an electronic money recharging machine (an example of a device capable of recharging an electronic value balance with a recharge amount) capable of recharging an electronic value balance with a recharge amount may be applied. In this case, after automatic recharging is performed by the electronic money recharging machine, electronic money payment is not made by the electronic money recharging machine.

In the above-described embodiments, the electronic money as a prepaid stored value has been described as an example, but the above embodiments can also be applied to an electronic money as a monetary value prepaid and stored in a server. In this case, the electronic money management server manages an electronic value balance of electronic money as a monetary value prepaid and stored in a server, in association with the user ID of the user of the mobile terminal 1 and the electronic money card number. As necessary, the mobile terminal 1 accesses the electronic money management server to acquire information indicating an electronic value balance. Thus, for example, it is determined, for example, whether the electronic value balance is equal to or smaller than the first threshold value.

### REFERENCE SIGNS LIST

1 mobile terminal
2a, 2b wireless communication device
3 electronic money payment machine
4 center server
5 credit card management server 5
11 storage unit
12 operation/display unit
13 communication unit
14 first short-range wireless communication unit
15 second short-range wireless communication unit
16 secure element
17 control unit
171 distance measurement unit
172 approach detection unit
173 threshold value setting unit
174 value balance determination unit
175 recharge amount determination unit
176 authorization requesting unit
177 recharge/payment processing unit
178 credit approval cancellation requesting unit
nw network
s electronic payment system

1. A mobile terminal, configured to be used for electronic money payment of electronic value stored in a predetermined storage, the mobile terminal configured to communicate with a predetermined server via a network and receive a radio signal transmitted from a wireless communication device provided integrally with or separately from a device capable of performing electronic money payment or a device capable of recharging an electronic value balance with a recharge amount, said mobile terminal comprising:
at least one memory configured to store computer program code;
at least one processor configured to read said computer program code and operate as instructed by said computer program code, said computer program code including:
measurement code configured to cause at least one of said at least one processor to measure a distance between the mobile terminal and the wireless communication device on the basis of the radio signal received by the reception means;
detection code configured to cause at least one of said at least one processor to detect when the mobile terminal is approaching the wireless communication device on the basis of a distance measured;
authorization requesting code configured to cause at least one of said at least one processor to transmit a request for authorization for a credit payment for a recharge amount for recharging the electronic value balance, to the server via the network, when approaching of the mobile terminal to the wireless communication device is detected; and
processing code configured to cause at least one of said at least one processor to perform processing of permitting recharging the electronic value balance with the recharge amount when credit approval is granted for the authorization.

2. The mobile terminal according to claim 1, further comprising
determination code configured to cause at least one of said at least one processor to perform determine whether electronic value balance stored in the storage is equal to or smaller than a first threshold value or smaller than the first threshold value,
wherein the authorization requesting code is configured to cause at least one of said at least one processor to transmit the authorization request only when the determination code causes at least one of the at least one processor to determine that the balance is equal to or smaller than the first threshold value or smaller than the first threshold value.

3. The mobile terminal according to claim 1, wherein the processing code is configured to cause at least one of said at least one processor to perform processing of permitting recharging the electronic value balance with the recharge amount only when credit approval is granted for the authorization and a distance measured is equal to or smaller than a second threshold value or smaller than the second threshold value.

4. The mobile terminal according to claim 3, further comprising setting code configured to cause at least one of said at least one processor to set the second threshold value larger as a moving speed of the mobile terminal is faster, the moving speed is calculated on the basis of a difference between distances and a difference in measurement time, and the difference between distances is obtained by measuring distances a plurality of times by the measurement code at different timings.

5. The mobile terminal according to claim 3, further comprising setting code configured to cause at least one of said at least one processor to identify time in the past at which the electronic money payment is made by the device capable of performing electronic money payment, from a payment history of the user, and set the second threshold value larger as an expectation value of the electronic money payment made through the device capable of performing electronic money payment in a time block including the identified time is larger.

6. The mobile terminal according to claim 1, further comprising:
first acquisition code configured to cause at least one of said at least one processor to acquire a necessary time required for the authorization; and
calculation code configured to cause at least one of said at least one processor to calculate expected arrival time at which the user arrives at the device, on the basis of moving speed and a latest distance, the moving speed is calculated on the basis of a difference between distances and a difference in measurement time, the difference between distances being obtained by measuring distances a plurality of times by the measurement code at different timings, and the latest distance being measured by the measurement code,
wherein the detection code is configured to cause at least one of said at least one processor to detect that the mobile terminal is approaching the wireless communication device, at a point of time earlier by the necessary time before the expected arrival time.

7. The mobile terminal according to claim 1, further comprising cancellation requesting code configured to cause at least one of said at least one processor to transmit a request for cancellation of the credit approval to the server via the network, when the electronic money payment of the electronic value is not performed within a predetermined time period after credit approval is granted for the authorization for the recharge amount.

8. The mobile terminal according to claim 1, further comprising cancellation requesting code configured to cause at least one of said at least one processor to transmit the request for cancellation of the credit approval to the server via the network, when electronic money payment of the electronic value is not performed within a predetermined time period after the radio signal is not received by the reception means after credit approval is granted for the authorization.

9. The mobile terminal according to claim 1, further comprising:
second acquisition code configured to cause at least one of said at least one processor to acquire payment amount information indicating a payment amount necessary for payment through the device capable of performing electronic money payment; and
determination code configured to cause at least one of said at least one processor to determine the recharge amount on the basis of a payment amount indicated by the payment amount information acquired by the second acquisition code and the electronic value balance,
wherein the authorization requesting code is configured to cause at least one of said at least one processor to transmit a request for authorization for a credit payment of the recharge amount determined.

10. The mobile terminal according to claim 9, wherein the second acquisition code is configured to cause at least one of said at least one processor to acquire the payment amount information from the radio signal received.

11. The mobile terminal according to claim 9, wherein the second acquisition code is configured to cause at least one of said at least one processor to identify, from the payment history of the user, a payment amount of the electronic money paid in the past through the device capable of performing electronic money payment, and acquire payment amount information indicating the identified payment amount, as payment amount information indicating a payment amount necessary for payment through the device capable of performing electronic money payment.

12. An information processing method performed by a mobile terminal and configured to be used for electronic money payment of electronic value stored in a predetermined storage means, the method comprising:
receiving a radio signal transmitted from a wireless communication device provided integrally with or separately from a device capable of performing electronic money payment or a device capable of recharging an electronic value balance with a recharge amount;
measuring a distance between the mobile terminal and the wireless communication device on the basis of the radio signal received;
detecting that the mobile terminal is approaching the wireless communication device on the basis of a distance measured;
transmitting a request for authorization for a credit payment for a recharge amount for recharging the electronic value balance, to a predetermined server via a network, when approaching of the mobile terminal to the wireless communication device is detected; and
processing permitting recharge of the electronic value balance with the recharge amount when credit approval is granted for the authorization.

13. A non-transitory computer readable medium having stored thereon, an information processing program for causing a computer included in a mobile terminal carried by a user and configured to be used for electronic money payment of electronic value stored in a predetermined storage:
measure a distance between the mobile terminal and a wireless communication device on the basis of a radio signal transmitted from the wireless communication device provided integrally with or separately from a device capable of performing electronic money payment or a device capable of recharging an electronic value balance with a recharge amount, and received by the mobile terminal;
detect that the mobile terminal is approaching the wireless communication device on the basis of a distance measured;
transmit a request for authorization for a credit payment for a recharge amount for recharging the electronic value balance, to a predetermined server via a network, when approaching of the mobile terminal to the wireless communication device is detected; and
process recharge permission of the electronic value balance with the recharge amount when credit approval is granted for the authorization.

14. A mobile device, comprising:
a communication circuitry configured to communicate with a server via a network;
a wireless communication circuitry configured to communicate with a wireless communication device that is set outside;
a memory that stores data regarding an electronic value; and
a control circuitry configured to
measure a distance between the mobile device and the wireless communication device based on a radio signal received from the wireless communication device;
detect that the mobile device is approaching the wireless communication device by comparing the distances measured a plurality of times at different timings;
transmit a request for authorization for a credit payment to the server via the network in response to detecting approaching of the mobile device to the wireless communication device; and
perform processing of recharging the electronic value by the credit payment in response to receiving a credit approval information for the authorization from the server.
